(19) United States
(12) Patent Application Publication
(10) Pub. No.: US 2012/0078954 A1
(43) Pub. Date: Mar. 29, 2012

(54) BROWSING HIERARCHIES WITH SPONSORED RECOMMENDATIONS

(75) Inventor: Carlos Araya, San Francisco, CA (US)

(73) Assignee: ROVI TECHNOLOGIES CORPORATION, Santa Clara, CA (US)

(21) Appl. No.: 12/981,354

(22) Filed: Dec. 29, 2010

Related U.S. Application Data
(60) Provisional application No. 61/386,462, filed on Sep. 24, 2010.

(51) Int. Cl. G06F 17/30

(52) U.S. Cl. 707/769; 707/E17.012; 707/E17.014

(57) ABSTRACT

Browsing content stored in a content source. A hierarchical tree structure is accessed. The hierarchical tree structure has nodes that correspond to at least one query for recommended content that is recommended based on sponsored recommendations. Recommended content stored in the content source is browsed by executing the at least one query for recommended content, the at least one query corresponding to at least one node of the hierarchical tree structure. The browsing is performed in accordance with a hierarchy of the hierarchical tree structure.

### CROSS REFERENCE TO RELATED APPLICATION

This application claims the benefit of U.S. Provisional Patent Application No. 61/386,462, filed on Sep. 24, 2010, the disclosure of which is incorporated by reference herein in its entirety.

### RELATED APPLICATIONS

The present patent application is related to the following patent applications each assigned to a common assignee:

Attorney Docket Number 2147.042US1, filed on Sep. 3, 2010 entitled, “A USER INTERFACE FOR CONTENT BROWSING AND SELECTION IN A CONTENT SYSTEM”, U.S. patent application Ser. No. 12/875,245, which is hereby incorporated by reference in its entirety.

Attorney Docket Number 03449.000029, filed on Sep. 3, 2010 entitled, “GUIDED NAVIGATION”, U.S. patent application Ser. No. 12/875,457, which is hereby incorporated by reference in its entirety.

Attorney Docket Number 03449.000037, filed on Sep. 3, 2010 entitled, “GENERATING BROWSING HIERARCHIES”, U.S. patent application Ser. No. 12/875,491, which is hereby incorporated by reference in its entirety.

Attorney Docket Number 03449.000038, filed on Sep. 3, 2010 entitled, “HIERARCHICAL DISPLAY OF CONTENT”, U.S. patent application Ser. No. 12/875,508, which is hereby incorporated by reference in its entirety.

### BACKGROUND

1. Field

Example aspects of the present disclosure generally relate to browsing content based on sponsored recommendations.

2. Related Art

Media servers have changed the way consumers store and view media content on televisions and/or other consumer electronic (“CE”) devices. Home entertainment networks further allow media stored on or accessible by a media server at a central location to be presented at multiple endpoints. A media server can be combined with or incorporated into a digital video recorder (DVR), a game console, a set top box, or as a media server application running, for example, on a PC. A media server also can be configured to automatically record media content, such as a television program, that is scheduled for broadcast at some time in the future.

Similarly, a media server can be configured to download or stream media content from the Internet, or from devices coupled either directly or through a network to the media server. Common devices used in conjunction with media servers include flash drives, hard drives, digital cameras, PC's, mobile telephones, personal digital assistants, and music players. The consumer controls the media server to view photos or video, play music, or present online content on a television or other CE device.

### BRIEF DESCRIPTION

In an example embodiment provided herein, content stored in a content source is browsed. A hierarchical tree structure is accessed. The hierarchical tree structure has nodes that correspond to at least one query for recommended content that is recommended based on sponsored recommendations. Recommended content stored in the content source is browsed by executing the at least one query for recommended content, the at least one query corresponding to at least one node of the hierarchical tree structure. The browsing is performed in accordance with a hierarchy of the hierarchical tree structure.

In another aspect, the content source includes a recommendation engine that adds sponsored recommendations to the content source as content information, and the sponsored recommendations of the content source are searched by using a search functionality of the content source.

In another aspect, the recommendation engine stores sponsor information for one or more sponsors, the sponsor information including a sponsor identification (ID), a sponsor state, sponsor display information, and one or more sponsored recommendations, the sponsor state identifying a sponsor as active or inactive.

In another aspect, a sponsor is active if the sponsor has been authorized by the content source to provide sponsored recommendations, and the sponsor is not active if the sponsor has not been authorized by the content source to provide sponsored recommendations.

In another aspect, content identification information for content recommended by the sponsor, and a sponsor identification for the sponsor, and the recommendation engine adds the sponsor's identification to the content source as content information for content that has a content identifier that matches the content identifier of the sponsored recommendation.

In another aspect, the recommendation engine obtains sponsor identification information for each active sponsor, accesses sponsored recommendations provided by each active sponsor, converts the accessed sponsored recommendations into a format of the content database, and adds the converted sponsored recommendations to the content source, as content information.

Further features and advantages, as well as the structure and operation, of various example embodiments of the present disclosure are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings in which like reference numbers indicate identical or functionally similar elements.

FIG. 1 is a diagram of an example media sever architecture in which some embodiments are implemented.

FIG. 2 is a block diagram of an example home network in which some embodiments are implemented.

FIG. 3 is a block diagram of an example media server.

FIG. 4 is a collaboration diagram of functional modules corresponding to the software architecture deployed on the media server shown in FIG. 1.

FIG. 5 is an interface use diagram for the software architecture shown in FIG. 4.

FIG. 6 is a module communication flow diagram for the software architecture shown in FIG. 4.

FIGS. 7A, 7B, and 7C illustrate content arranged in a hierarchical structure according to example embodiments.

FIG. 8 illustrates content arranged in a hierarchical structure according to an example embodiment.

FIG. 9 is a sequence diagram for explaining an example procedure for browsing content stored in a content source.

FIG. 10 is a flowchart diagram for explaining an example procedure for browsing content stored in a content source.

FIG. 11 illustrates a guided browse function.

FIG. 12 shows an example of static nodes and dynamic nodes in the user interface presented by the presentation layer module.

FIG. 13 illustrates the getChildren( ) module of the guided browse function.

FIG. 14 is diagram of an example content source in which some embodiments are implemented.

FIG. 15 is a flow diagram for explaining an example procedure for generating recommendations.

FIG. 16 is a block diagram of a general and/or special purpose computer, in accordance with some embodiments.

### DETAILED DESCRIPTION

Example aspects and embodiments are now described in more detail herein. This is for convenience only and is not intended to limit the application of the present description. In fact, after reading the following description, it will be apparent to one skilled in the relevant art(s) how to implement alternative embodiments.

### DEFINITIONS

The following terms are defined below for reference. These terms are not rigidly restricted to these definitions. A term may be further defined by its use in other sections of this description.

“Album” means a collection of tracks. An album is typically originally published by an established entity, such as a record label (for example, a recording company such as Warner Brothers and Universal Music).

The terms “program,” “multimedia program,” “show,” and the like include e-book (electronic book) content, video content, audio content, applications, animations, and the like. Applications include code, scripts, widgets, games and the like. Video content includes television programs, movies, video recordings, and the like. Audio content includes music, audio recordings, podcasts, radio programs, spoken audio, audiobook content, and the like. The terms “program,” “multimedia program,” and “show,” include scheduled content and unscheduled content. Scheduled content includes, for example, broadcast content and multicast content. Unscheduled content includes, for example, on-demand content, pay-per-access content, downloaded content, streamed content, and stored content.

The terms “content,” “media content,” “multimedia content,” and the like include e-book content, video content, audio content, still imagery, applications, animations, and the like. Applications include code, scripts, widgets, games and the like. Video content includes television programs, movies, video recordings, and the like. Audio content includes music, audio recordings, podcasts, radio programs, spoken audio, audiobook content, and the like. Still imagery includes photos, graphics, and the like. The terms “content,” “media content,” and “multimedia content” include scheduled content and unscheduled content. Scheduled content includes, for example, broadcast content and multicast content. Unscheduled content includes, for example, on-demand content, pay-per-access content, downloaded content, streamed content, and stored content.

“Electronic program guide” or “EPG” data are typically displayed on-screen and can be used to allow a viewer to navigate, select, and discover content by time, title, channel, genre, etc. by use of a remote control, a keyboard, a mouse, a trackball, a touchpad, a stylus, or other similar input devices. In addition, EPG data can be used to schedule future recording by a digital video recorder (DVR) or personal video recorder (PVR).

“Song” means a musical composition. A song is typically recorded onto a track by a record label (such as, a recording company). A song may have many different versions, for example, a radio version and an extended version.

“Track” means an audio and/or video data block. A track may be on a disc, such as, for example, a Blu-ray Disc, a CD or a DVD.

“User” means a consumer, client, and/or client device in a marketplace of products and/or services.

“User device” (such as “client”, “client device”, “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a television, a CD player, a DVD player, a Blu-ray Disc player, a personal media device, a portable media player, an iPod™, a Zoom Player, a laptop computer, a palmtop computer, a smart phone, a cell phone, a mobile phone, an MP3 player, a digital audio recorder, a digital video recorder, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox™ and Microsoft Internet Explorer™.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

### System Architecture

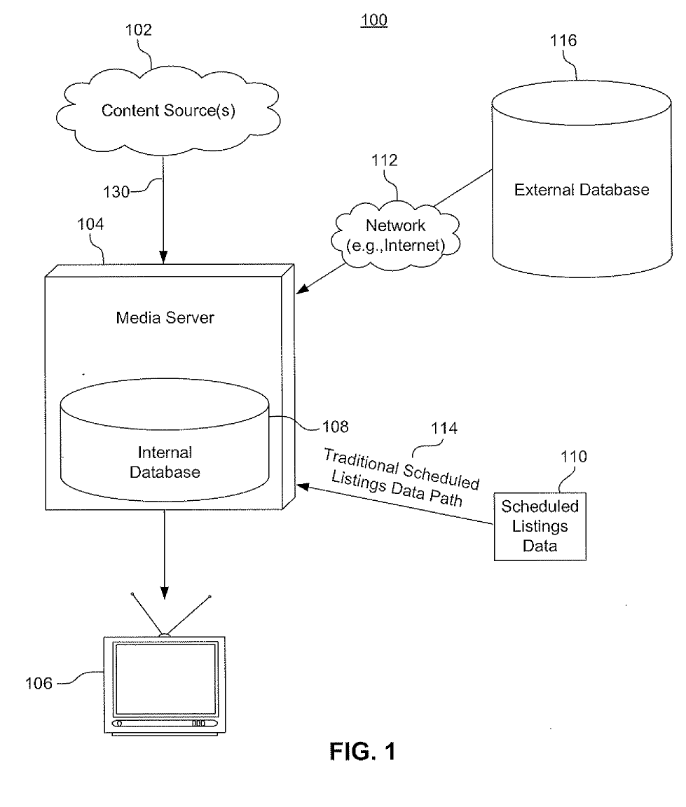

FIG. 1 is a diagram of a media server architecture 100 in which some embodiments are implemented. As shown in FIG. 1, the media server architecture 100 includes at least one content source 102. Content source 102 provides content and related content information. Content information will be described below in more detail. The media server 104 accesses the content source 102 and retrieves multimedia content and content information from the content source 102 via multimedia signal lines 130 of FIG. 1. Multimedia signal lines 130 include multimedia signal lines of a variety and/or a combination of wired and/or wireless audio, video and/or television content distribution and/or delivery networks such as, for example, cable, satellite, terrestrial, analog, digital, standard definition, high definition, RF (UHF, VHF) and/or broadcast networks, multimedia signal lines of a variety and/or combination of wired and/or wireless wide-area data networks, such as, for example, the Internet, an intranet, and the like.

Multimedia content includes e-book content, video content, audio content, still imagery, applications, animations, and the like. Applications include code, scripts, widgets, games and the like. Video content includes television programs, movies, video recordings, and the like. Audio content includes music, audio recordings, podcasts, radio programs, spoken audio, audiobook content, and the like. Still imagery includes photos, graphics, and the like. The terms “content,” “media content,” and “multimedia content” include scheduled content and unscheduled content. Scheduled content includes, for example, broadcast content and multicast content. Unscheduled content includes, for example, on-demand content, pay-per-access content, downloaded content, streamed content, and stored content.

In one embodiment, the media server 104 is a personal computer (PC) running a media server application such as Windows Media Center, or the like. Content from the content source 102 may be delivered through different types of transmission paths. Example transmission paths include a variety and/or combination of wired and/or wireless audio, video and/or television content distribution and/or delivery networks such as, for example, cable, satellite, terrestrial, analog, digital, standard definition, high definition, RF (UHF, VHF) and/or broadcast networks. Example transmission paths also include a variety and/or combination of wired and/or wireless wide-area data networks, such as, for example, the Internet, an intranet, and the like.

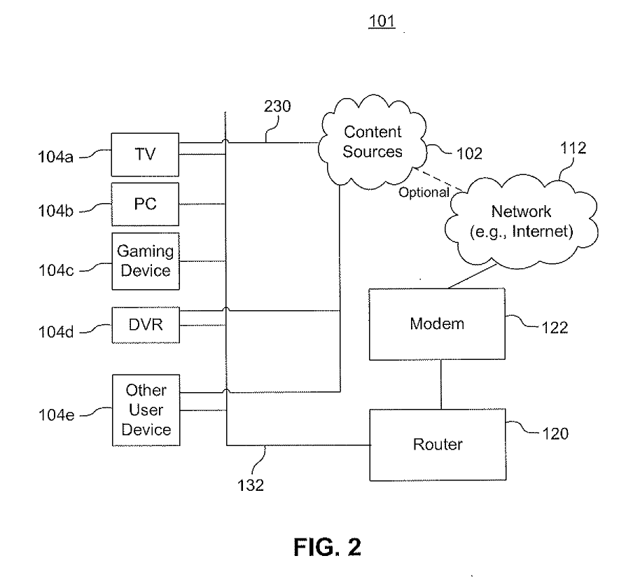

The media server 104 records multimedia content in a selected format to a disk drive or to another suitable storage device. The media server 104 is communicatively coupled to a user device 106, such as a television, an audio device, a video device, and/or another type of user and/or CE device. The media server 104 delivers the multimedia content to the user device 106 upon receiving the appropriate instructions from a suitable user input device, such as a remote control device, a keyboard, a mouse, a trackball, a touchpad, a stylus, buttons located on the media server 104, itself, or other similar input devices. In turn, the user device 106 presents the multimedia content to a user. In some cases the user device 106 is part of a network, as further described below in relation to FIG. 2.

A user can control the operation of the user device 106 via a suitable user input means, such as buttons located on the user device 106, itself or a remote control device, a keyboard, a mouse, a trackball, a touchpad, a stylus, or other similar input devices. In one embodiment, a single remote control device can be used to control both the user device 106 and the media server 104. The multimedia content recorded onto the media server 104 is viewed and/or heard by the user at a time chosen by the user.

The media server 104 may be located in close proximity to a user device 106, or may exist in a remote location, such as in another room of a household, or on a server of a multimedia content provider.

The media server 104 periodically receives scheduled listings data 110 via a traditional scheduled listings data path 114 through a network, such as a proprietary network or the Internet. The media server 104 stores the received scheduled listings data 110 in a suitable storage device.

The scheduled listings data 110, are typically provided by a content provider, and include schedule information corresponding to specific multimedia programs. The scheduled listings data 110 typically are used in conjunction with EPG data, which, as described above, are used to provide media guidance for content including scheduled and unscheduled television content as well as other forms of content. The media guidance is provided by, for example, a media guidance module. The media guidance allows a user to navigate, select, discover, search, browse, view, “consume,” schedule, record, and/or playback recordings of content by time, title, channel, genre, etc., by use of a user input device, such as a remote control device, a keyboard, a mouse, a trackball, a touchpad, a stylus, buttons located on the media server, itself, or other similar input devices.

As shown in FIG. 1, the media server 104 also includes an internal database 108, which stores “content information.” As described above, the content source 102 provides content information for content provided by content source 102. The content information may include data and/or metadata that provide additional information about content. Example content information include biographical information on authors, writers, actors, directors, producers, or the like, background information on related content, web links or text identifiers for related content, information identifying recommended content, information identifying related content, information related to categories, genres, or the like for related content, information identifying other users and/or viewers who may share an interest similar to a particular item of content, content reviews, advertisements, and other content information related to a particular item of content. Content reviews include, for example, summaries, critiques, overviews, polling or survey information, or other type of analysis, opinion, or parody of a particular item of content. For instance, when the content includes television and/or movie content, the content information may include data about actors, genre, directors, reviews, ratings, awards, languages, year of release, and/or other information that is of interest to users or consumers of the content. Although FIG. 1 shows the database 108 as being internal to the media server 104, embodiments including an internal database, an external database, or both are contemplated and are within the scope of the present disclosure. Further, one or more functions of the media server 104 may be implemented or incorporated within the user device 106. Moreover, one or more functions of the media server 104 may be implemented or incorporated within the database 108 in some embodiments.

In one embodiment, an external database 116 is located on a server remote from the media server 104, and communicates with the media server 104 via a network 112, such as a proprietary network or the Internet. As new theme song data is generated and/or discovered, updates can be requested by the internal database 108, or automatically pushed to the internal database 108 from the external database 116 over the network 112. For example, if a new multimedia program is scheduled to appear in an upcoming season, new corresponding theme song data can be generated, stored in the external database 116, and downloaded to the internal database 108 before the new program is delivered.

Internal database 108 and/or the external database 116 may also be divided into multiple distinct databases. For example, the internal database 108 may be divided based on the type of data being stored by generating a database configured for storing photos, video, music, etc.

Upon scheduling a multimedia program, the media server 104 tunes to the channel based on received scheduled listings data 110 at a predetermined amount of time prior to the scheduled program start time. Once tuned to the channel, the media server 104 captures a portion of audio content received from the content source 102.

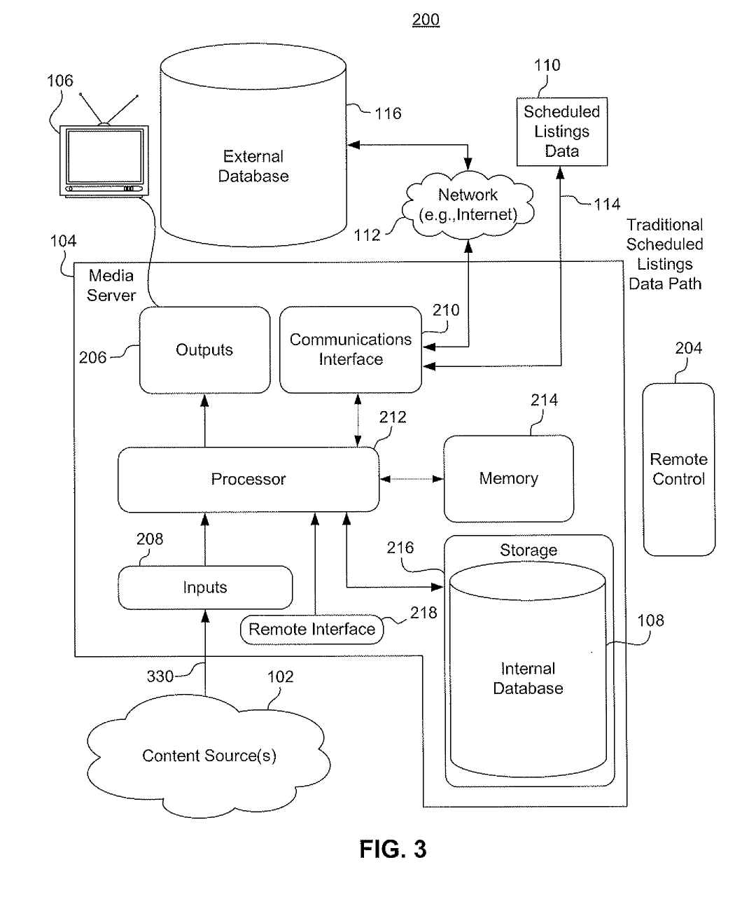

FIG. 2 is a block diagram of a network 101, in which some embodiments are implemented. The network 101 may include a home entertainment network, for instance. On the network 101 are a variety of user devices, such as a network ready television 104a, a personal computer 104b, a gaming device 104c, a digital video recorder 104d, other devices 104e, and the like. The user devices 104a through 104e may access content sources 102 and retrieve multimedia content from the content sources 102 via multimedia signal lines 230. Multimedia signal lines 230 include multimedia signal lines of a variety and/or a combination of wired and/or wireless audio, video and/or television content distribution and/or delivery networks such as, for example, cable, satellite, terrestrial, analog, digital, standard definition, high definition, RF (UHF, VHF) and/or broadcast networks, multimedia signal lines of a variety and/or combination of wired and/or wireless wide-area data networks, such as, for example, the Internet, an intranet, and the like. The content may be retrieved via an input interface such as the input interface 208 described below in connection with FIG. 3. In addition, user devices 104a through 104e may communicate with each other via a wired or wireless router 120 via network connections 132, such as Ethernet connections. The router 120 couples the user devices 104a through 104e to the network 112, such as the Internet, via a modem 122. In an alternative embodiment, the content sources 102 are accessed from the network 112.

FIG. 3 illustrates a more detailed diagram of the media server 104 within a system 200 in accordance with some embodiments. The media server 104 includes a processor 212 which is coupled through a communication infrastructure to an output interface 206, a communications interface 210, a memory 214, a storage device 216, a remote control interface 218, and an input interface 208.

The media server 104 accesses content source(s) 102 and retrieves content in a form such as audio and video streams from the content source(s) 102 via multimedia signal lines 330 of FIG. 3 and through the input interface 208. Multimedia signal lines 330 include multimedia signal lines of a variety and/or a combination of wired and/or wireless audio, video and/or television content distribution and/or delivery networks such as, for example, cable, satellite, terrestrial, analog, digital, standard definition, high definition, RF (UHF, VHF) and/or broadcast networks, multimedia signal lines of a variety and/or combination of wired and/or wireless wide-area data networks, such as, for example, the Internet, an intranet, and the like. The input interface 208 can be any suitable interface, such as an HDMI (High-Definition Multimedia Interface), Radio Frequency (RF), coaxial cable, composite video, S-Video, SCART, component video, D-Terminal, or VGA. In the example shown in FIG. 3, content signals, such as audio and video, retrieved via the input interface 208 from the content source(s) 102 are communicated to the processor 212 for further processing.

The media server 104 also includes a main memory 214. In one example embodiment, the main memory 214 is random access memory (RAM). The media server 104 also includes a storage device 216. In one example embodiment, the database 108, which, as described above, stores theme song data, is included in the storage device 216. The storage device 216 (also sometimes referred to as “secondary memory”) may also include, for example, a hard disk drive and/or a removable storage drive, representing a disk drive, a magnetic tape drive, an optical disk drive, etc. As will be appreciated, the storage device 216 may include a computer-readable storage medium having stored thereon computer software and/or data.

In alternative embodiments, the storage device 216 may include other similar devices for allowing computer programs or other instructions to be loaded into the media server 104. Such devices may include, for example, a removable storage unit and an interface, a program cartridge and cartridge interface such as that found in video game devices, a removable memory chip such as an erasable programmable read only memory (EPROM), or programmable read only memory (PROM) and associated socket, and other removable storage units and interfaces, which allow software and data to be transferred from the removable storage unit to the media server 104.

The communications interface 210 provides connectivity to a network 112, such as a proprietary network or the Internet. The communications interface 210 also allows software and data to be transferred between the media server 104 and external devices. Examples of the communications interface 210 may include a modern, a network interface such as an Ethernet card, a communications port, a Personal Computer Memory Card International Association (PCMCIA) slot and card, and the like. In one example embodiment, communications interface 210 is an electronic communications interface, but in other embodiments, communications interface 210 can be an electromagnetic, optical, or other suitable type of communications interface 210. The transferred software and data are provided to and/or from the communications interface 210 via a communications path. This communication path may be implemented by using wire, cable, fiber optics, a telephone line, a cellular link, an RF link, and/or other suitable communication path.

In one embodiment, the communications interface 210 provides connectivity between the media server 104 and the external database 116 via the network 112. The communications interface 210 also provides connectivity between the media server 104 and the scheduled listings data 110 via the traditional scheduled listings data path 114. The network 112 includes a proprietary network and/or the Internet.

A remote control interface 218 decodes signals received from a remote control 204, such as a television remote control or other user input device, and communicates the decoded signals to the processor 212. The decoded signals, in turn, are translated and processed by the processor 212.

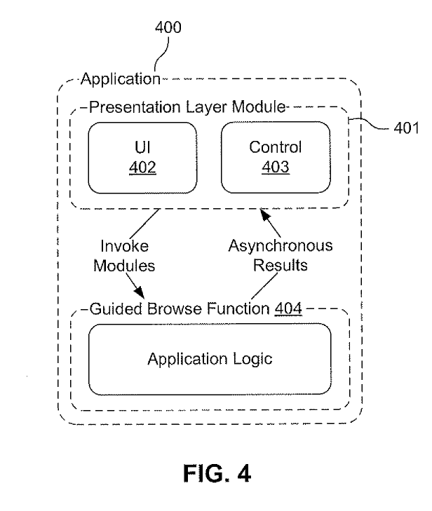

FIG. 4 is a collaboration diagram of functional modules corresponding to the software architecture deployed on the media server 104 shown in FIG. 1 and FIG. 3. A media server application 400 is stored in a storage device 216 of the media server 104 of FIG. 1 and FIG. 3, as computer-executable process steps encoded in machine-executable instructions.

A processor 212 first loads the computer-executable process steps (encoded in machine-executable instructions) from storage device 216, or another storage device into a region of a memory 214. Once loaded, the processor 212 executes the stored process steps stored in the memory 214.

As shown in FIG. 4, the media server application 400 includes a presentation layer module 401 and a guided browse function 404. The guided browse function is sometimes referred to as a guided browse model. The presentation layer module 401 further includes a user interface module 402 and a control module 403. The presentation layer and example embodiments of a presentation layer user interface are described in the U.S. patent application entitled “A USER INTERFACE FOR CONTENT BROWSING AND SELECTION IN A CONTENT SYSTEM”, Attorney Docket Number 2147.042US1, filed on Sep. 3, 2010, U.S. patent application Ser. No. 12/875,245, which is hereby incorporated by reference in its entirety.

As will be described below in more detail, the presentation layer module 401 accesses the guided browse function 404, which includes a hierarchical tree structure having nodes that correspond to at least one query. The presentation layer module 401 sends the guided browse function 404 a request to receive at least one static visual representation of a node that is in a top level of the hierarchical tree structure. The presentation layer module 401 receives the static visual representations of at least one node that is in the top level of the hierarchical tree structure. The presentation layer module 401 displays the received static visual representation such that it is selectable by a user. In an example embodiment, the presentation layer also receives content information for content associated with the received static visual representation, and the presentation layer module 401 displays the received content information such that it is selectable by a user. In response to user selection of the static visual representation, the presentation layer module 401 sends the guided browse function 404 a request to execute a corresponding static query to receive visual representations of content stored in the content source, and displays the received visual representations such that they are selectable by the user. In an example embodiment, after the static query is executed, the presentation layer also receives content information associated with the received visual representations, and the presentation layer module 401 displays the received content information such that it is selectable by a user. In response to user selection of a received visual representation that represents a collection of related content, the presentation layer module 401 sends the guided browse function 404 a request to execute a corresponding dynamic query to receive visual representations of content stored in the content source, and displays the visual representations received from the dynamic query such that they are selectable by the user. The dynamic query corresponds to a node that is a child of a node that corresponds to a previously executed query. The visual representations received from the dynamic query match the corresponding selected visual representation. In an example embodiment, after the dynamic query is executed, the presentation layer also receives content information associated with the received visual representations, and the presentation layer module 401 displays the received content information such that it is selectable by a user.

In the example embodiment, the presentation layer module 401 is stored as computer-executable process steps encoded in machine-executable instructions. The computer-executable process steps are for browsing content stored in the content source. The computer-executable process steps of the presentation layer module 401 are stored in storage device 216 of the media server 104 of FIG. 1 and FIG. 3. The computer-executable process steps of the presentation layer module 401 are executed by processor 212 of the media server 104 of FIG. 1 and FIG. 3.

In other embodiments, the presentation layer module 401 of FIG. 4 is a hardware device that includes electronic circuitry constructed to browse content stored in the content source. In an example embodiment, the electronic circuitry includes special purpose processing circuitry that is constructed to browse content stored in the content source. In other example embodiments, the electronic circuitry includes at least one general purpose processor that is constructed to execute computer-executable process steps encoded in machine-executable instructions that are stored on the computer-readable storage medium of the hardware device. The computer-executable process steps executed by the general purpose processor include computer-executable process steps for browsing content stored in the content source.

The guided browse function 404 is constructed from a content source identifier. The content source identifier identifies a content source that is searched by the guided browse function 404. In response to receiving a request to browse content, the guided browse function 404 is constructed to search the content stored in the identified content source.

In the example embodiment, the guided browse function 404 is stored as computer-executable process steps encoded in machine-executable instructions. The computer-executable process steps are for searching the content stored in the content source. The computer-executable process steps of the guided browse function 404 are stored in storage device 216 of the media server 104 of FIG. 1 and FIG. 3. The computer-executable process steps of the guided browse function 404 are executed by processor 212 of the media server 104 of FIG. 1 and FIG. 3.

In other embodiments, the guided browse function 404 of FIG. 4 is a hardware device that includes a computer-readable storage medium that stores the content source identifier. The hardware device further includes electronic circuitry constructed to search the content stored in the content source, in response to receiving a request to browse content. In an example embodiment, the electronic circuitry includes special purpose processing circuitry that is constructed to search the content stored in the content source. In other example embodiments, the electronic circuitry includes at least one general purpose processor that is constructed to execute computer-executable process steps encoded in machine-executable instructions that are stored on the computer-readable storage medium of the hardware device. The computer-executable process steps executed by the general purpose processor include computer-executable process steps for searching the content stored in the content source, in response to receiving a request to browse content.

The guided browse function 404 of FIG. 4 has both a non-native browse mode and a native browse mode. In the example embodiment, when the guided browse function 404 is generated, it is generated to be in either a non-native browse mode or native browse mode. In other embodiments, the guided browse function 404 is generated such that it may be enabled for either native browse mode or non-native browse mode. In a case where the guided browse function 404 is in the native browse mode, the guided browse function 404 browses the native tree hierarchy of the content source 102 of FIGS. 1, 2 and 3.

In a case where the guided browse function 404 is in the non-native browse mode, the guided browse function 404 includes a hierarchical structure that defines a hierarchy of content stored in the content source that is independent of the file structure of the content stored in the content source. The hierarchical structure includes nodes that represent search queries. In response receiving a request to browse content corresponding to a selected node in the hierarchical tree structure, the guided browse function 404, when in the non-native browse mode, searches the content stored in the content source by using a search query corresponding to the selected node in the hierarchical structure. Thus, the search query used by the guided browse function 404 in the non-native browse mode is determined in accordance with the hierarchical structure that defines the hierarchy of content stored in the content source. In this manner, the guided browse function 404 in the non-native browse mode browses content stored in the content source by sequentially executing queries corresponding to nodes of the hierarchical tree structure, in accordance with a hierarchy of the hierarchical tree structure. In the embodiments described above in which the guided browse function 404 of FIG. 4 is a hardware device that includes a computer-readable storage medium, the hierarchical structure is stored on the computer-readable storage medium. In the embodiments described above in which the guided browse function 404 of FIG. 4 is stored as computer-executable process steps stored on a computer-readable storage medium, the hierarchical structure is stored on the computer-readable storage medium, such as, for example, storage device 216 of the media server 104 of FIG. 1 and FIG. 3.

In the example embodiment, and as described above with respect to the presentation layer module 401, the hierarchical structure is a tree structure that contains tree nodes. The tree nodes are composed of two groups, “static nodes” and “dynamic nodes”.

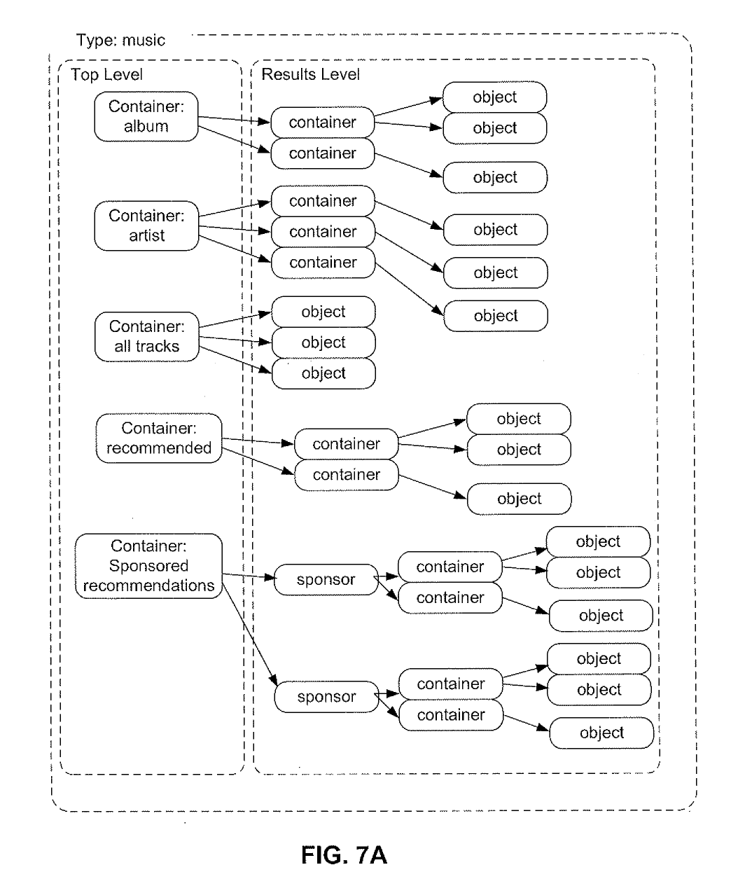

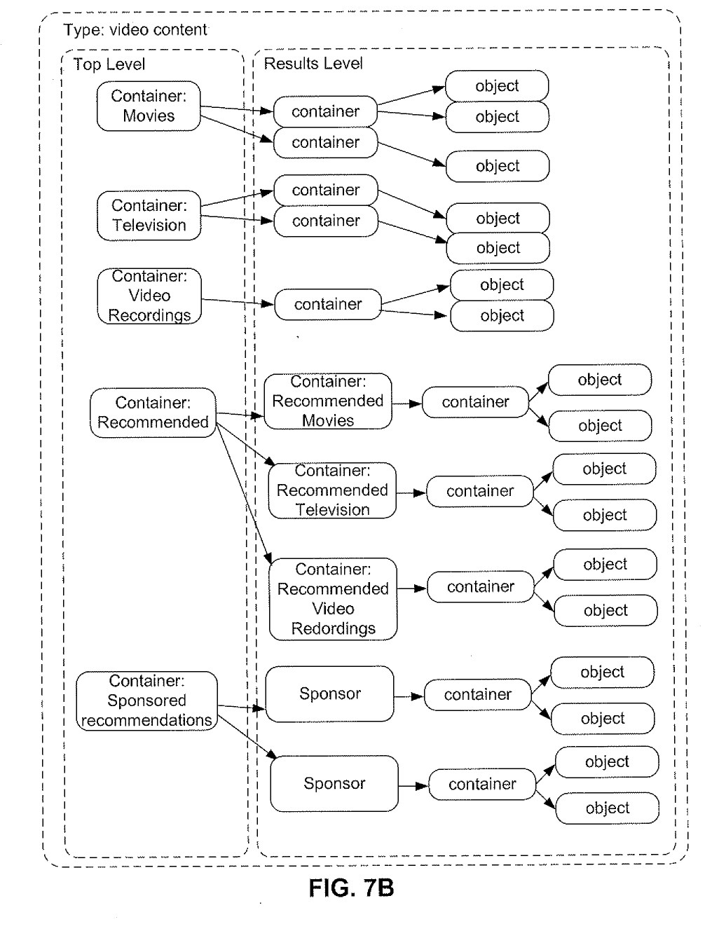

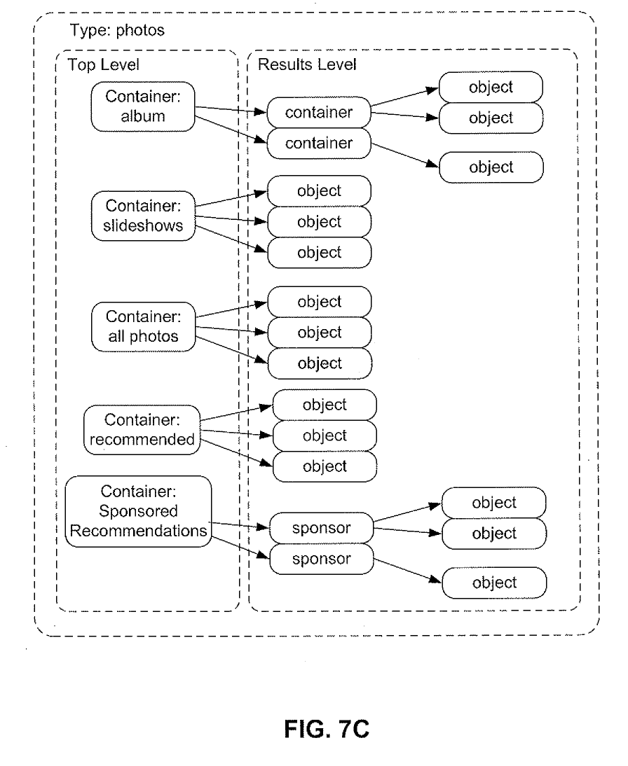

A “static node” corresponds to a static query for content stored in the content source. A static query is a query whose query terms are predefined. An example static query for music content is a query to search for all “Artists” represented by the content stored in the content source. A “dynamic node” represents the results of a search operation. Queries corresponding to dynamic nodes are dynamic queries. A dynamic query is a query that includes one or more dynamic query terms that are determined during execution of the dynamic query. In the example embodiment, one or more terms of a dynamic query are determined based on a selected search result of a previously executed query. An example dynamic query for music content is a query for all “Albums” of a selected artist that is identified by performing a static query for all “Artists”. In this example, a dynamic query term corresponds to the selected artist Example hierarchical structures are described in more detail below with respect to FIGS. 7A, 7B, 7C, 8 and 11.

The data returned by the guided browse function 404 includes content objects and container objects. A container object represents a collection of related content objects. A content object represents media content that is presented by the presentation layer module 401. As described above, media content includes e-book (electronic book) content, video content, audio content, still imagery, applications, animations, and the like. Applications include code, scripts, widgets, games and the like. Video content includes television programs, movies, video recordings, and the like. Audio content includes music, audio recordings, podcasts, radio programs, spoken audio, audiobook content, and the like. Still imagery includes photos, graphics, and the like. The terms “content,” “media content,” “multimedia content” include scheduled content and unscheduled content. Scheduled content includes, for example, broadcast content and multicast content. Unscheduled content includes, for example, on-demand content, pay-per-access content, downloaded content, streamed content, and stored content.

A content object includes an Application Programming Interface (API) that exposes a getName( ) module. The getName( ) module returns the display name, or other visual representation, such as, for example, an icon or thumbnail of the content object, and a module that is called by the presentation layer module 401 to present the media content that is represented by the content object. The content object's interface or API also exposes a getInterface( ) module that is used to determine that the content object is a content object, as distinguished from a container object. In an example embodiment, the content object represents content information for content represented by the content object, and the content object's interface or API also exposes a ContentInformation( ) module that returns content information for the content represented by the content object.

A container object includes an API that exposes a displayName( ) module that returns the display name or other visual representation, such as, for example, an icon or thumbnail of the container object. The container object's interface or API also exposes a getInterface( ) module that is used to determine that the container object is a container object, as distinguished from a content object. In an example embodiment, the container object represents content information for content objects represented by the container object, and the container object's interface or API also exposes a ContentInformation( ) module that returns the content information represented by the container object.

In the example embodiment, the content object's getName( ) module, the content object's getInterface( ) module, the content object's ContentInformation( ) module, the container object's displayName( ) module, the container object's getInterface( ) module, and the container object's ContentInformation( ) module are each stored as compute-executable process steps encoded in machine-executable instructions. The computer-executable process steps of the modules are stored in storage device 216 of the media server 104 of FIG. 1 and FIG. 3. The computer-executable process steps of the modules are executed by processor 212 of the media server 104 of FIG. 1 and FIG. 3.

In other embodiments, one or more of the content object's getName( ) module, the content object's getInterface( ) module, the content object's ContentInformation( ) module, the container object's displayName( ) module, the container object's getInterface( ) module, and the container object's ContentInformation( ) module are hardware devices that include electronic circuitry constructed to perform the respective process. In an example embodiment, the electronic circuitry includes special purpose processing circuitry. In other example embodiments, the electronic circuitry includes at least one general purpose processor that is constructed to execute computer-executable process steps encoded in machine-executable instructions that are stored on a computer-readable storage medium of the hardware device.

In the case where the guided browse function 404 of FIG. 4 is in the non-native browse mode, each container object corresponds to a node of the hierarchical structure of the guided browse function 404, and each such node corresponds to a search query for content stored in the content source. Thus, each container node corresponds to a search query.

In the case where the guided browse function 404 is in the native browse mode, each container object corresponds to a container in the native tree hierarchy of the content source.

Generally, a user controls the media server application 400 to browse and play media content. When the media server application 400 is accessed by a user, as will be described below in more detail, the media server application 400 receives user identification information that identifies the user. The media server application 400 stores the received user identification. The user identification information of a user currently accessing the media server application 400 is stored as user identification information of a current user. By using an input device, the user interacts with a user interface module 402 to select a displayed item for example, that is displayed on a display or user device 106. The displayed items include display names, or other visual representations, such as, for example, icons or thumbnails of content objects, container objects, and content information.

In response to the user's selection of the displayed item, the presentation layer module 401 determines whether the item corresponds to a content object or a container object. If the selected item corresponds to a content object, then the presentation layer module 401 presents the content represented by the content object, for example, by playing audio, video, or an animation, by running an application, or by displaying still imagery.

If the selected item is a container object, then the user interface module 402 asks the guided browse function 404 for objects such as container objects, or content objects that are contained within the selected container object. In a case where the guided browse function 404 is in the non-native browse mode, the objects contained in the selected container object are defined according to the hierarchical structure used by the guided browse function 404. In a case where the guided browse function 404 is in the native browse mode, the objects contained in the selected container object are defined according to the native tree hierarchy of the content source corresponding to the container object. The user interface module 402 asks the guided browse function 404 for objects contained in the selected container object by invoking or calling a getChildren( ) module that is exposed by the interface or API of the guided browse function 404. The getChildren( ) module provides objects contained in a selected container object. The getChildren( ) module defines an optional parameter for specifying user identification of a current user. The user interface module 402 accesses the stored user identification information of the current user, and specifies the user identification information of the current user when invoking the getChildren( ) module.

In the example embodiment, the guided browse function 404's getChildren( ) module is stored as computer-executable process steps encoded in machine-executable instructions. The computer-executable process steps of the getChildren( ) module are stored in storage device 216 of the media server 104 of FIG. 1 and FIG. 3. The computer-executable process steps of the getChildren( ) module are executed by processor 212 of the media server 104 of FIG. 1 and FIG. 3.

In other embodiments, the getChildren( ) module is a hardware device that includes electronic circuitry constructed to provide objects contained in a selected container object. In an example embodiment in which the guided browse function 404 is a hardware device, the getChildren( ) module is electronic circuitry that is included in the guided browse function 404 hardware device. However, in other embodiments, the guided browse function 404 and the getChildren( ) module are separate hardware devices. In an example embodiment, the electronic circuitry includes special purpose processing circuitry. In other example embodiments, the electronic circuitry includes at least one general purpose processor that is constructed to execute computer-executable process steps encoded in machine-executable instructions that are stored on a computer-readable storage medium of the hardware device.

It should be understood that in various embodiments both the guided browse function 404 and the getChildren( ) module are hardware devices. In other embodiments, the guided browse function 404 is a hardware device and the getChildren( ) module is computer-executable process steps stored on a computer-readable storage medium. In other embodiments, the guided browse function 404 is computer-executable process steps stored on a computer-readable storage medium, and the getChildren( ) module is a hardware device. In other embodiments, both the guided browse function 404 and the getChildren( ) module are computer-executable process steps stored at least one computer-readable storage medium.

Reverting to the discussion of user selection of a displayed item, in a case where the presentation layer module 401 determines that a user has selected a displayed item that corresponds to a container object, and the guided browse function 404 of FIG. 4 is not in the native browse mode, in response to the selection of the container object, the guided browse function 404 searches the content stored in the content source by using a search query. The search query corresponds to the selected container object and returns results of the search such as, for example, the objects contained in the selected container object, to the presentation layer module 401, asynchronously, via a control module 403. The presentation layer module 401 in turn presents received data to the user by, for example, displaying the data on a display provided by the user device 106, for instance.

In a case where the presentation layer module 401 determines that a user has selected a display item that corresponds to a container object, and the guided browse function 404 is in the native browse mode, in response to the selection of the container object, the guided browse function 404 browses the file structure of the content source, and returns the content stored in the content source to the presentation layer module 401, asynchronously, via the control module 403. The presentation layer module 401 presents received data to the user by, for example, displaying the results data on a display of the device 106. Thus, the native browse function returns data, such as the objects contained in the selected container object, returned in response to the user's selection according to the file structure of the content stored in the content source.

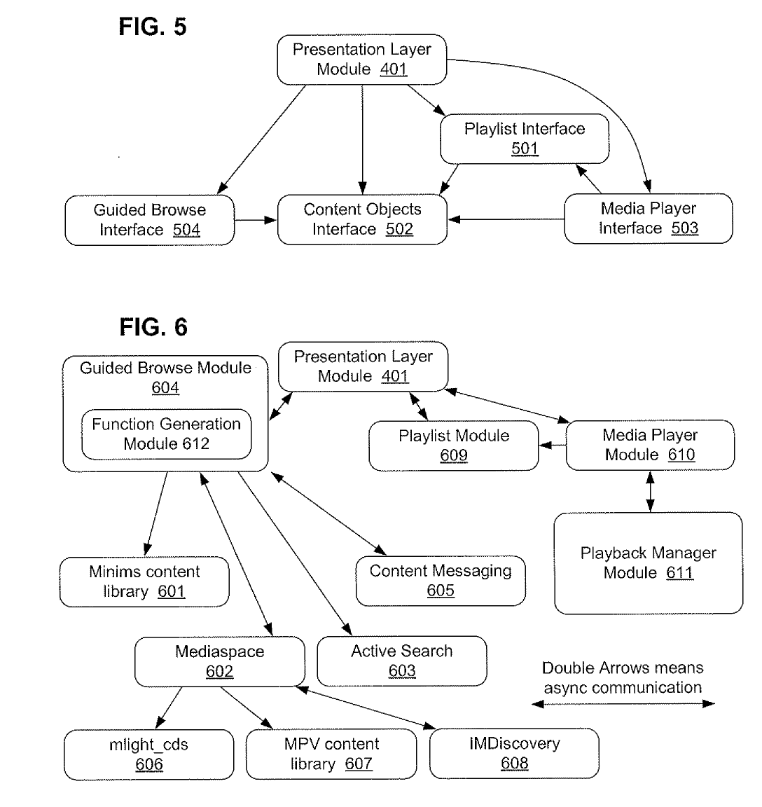

FIG. 5 is an interface diagram for the software architecture shown in FIG. 4. The guided browse interface 504 of FIG. 5 defines the modules provided by the guided browse function 404 of FIG. 4.

In the example embodiment, the modules provided by the guided browse function 404 are stored as computer-executable process steps encoded in machine-executable instructions. The computer-executable process steps of the modules are stored in storage device 216 of the media server 104 of FIG. 1 and FIG. 3. The computer-executable process steps of the modules are executed by processor 212 of the media server 104 of FIG. 1 and FIG. 3. In other embodiments, the modules are hardware devices that include electronic circuitry constructed to perform a respective function. In an example embodiment, the electronic circuitry includes special purpose processing circuitry. In other example embodiments, the electronic circuitry includes at least one general purpose processor that is constructed to execute computer-executable process steps encoded in machine-executable instructions that are stored on a computer-readable storage medium of the hardware device

The presentation layer module 401 of FIG. 5 asks the guided browse function 404 of FIG. 4 for data for selected containers, displays names of content objects, runs, plays or displays media content represented by a content object, and plays playlists that contain content objects.

For instance, as shown in FIG. 5, the guided browse interface 504 exposes the getChildren( ) module of the guided browse function 404. In this example, the presentation layer module 401 asks the guided browse function 404 for data for a selected container, by calling the getChildren( ) module of the guided browse interface 504. In response to the user selection of a displayed container object, for each content object included in the selected container object, the guided browse function 404 uses the content object interface 502 to get the corresponding name of the content object that is to be displayed by the presentation layer module 401, and uses the content object interface 502 to get any corresponding content information that is to be displayed by the presentation layer module 401.

The presentation layer module 401 uses the content object interface 502 to get data for a selected content object that is to be played, run, or displayed. In particular, the presentation layer module 401 accesses the stored user identification information of the current user. The presentation layer module 401 uses the content object interface 502 of the selected content object to provide the user identification information of the current user to the selected content object and to get data for the selected content object.

The presentation layer module 401 uses the playlist interface 501, of a playlist to get data for a selected playlist that is to be played, run, or displayed. In particular, the presentation layer module 401 accesses the stored user identification information of the current user. The presentation layer module 401 uses the playlist interface 501 of the selected playlist object to provide the user identification information of the current user to the selected playlist object and to get data for the selected playlist object.

In response to the user selection, for each content object included in the selected playlist, the playlist object uses the content object interface 502 to get the corresponding name of the content object that is to be displayed by the presentation layer module 401, and uses the content object interface 502 to get any corresponding content information that is to be displayed by the presentation layer module 401.

The presentation layer module 401 uses the media player interface 503, of a media player, to play, run or display either a selected playlist or a selected content object. In the case where a selected playlist is to be played, the media player uses the playlist interface 501 to get data for the selected playlist that is to be played. In turn, the playlist object uses the content object interface 502 to get the data for each content object included in the selected playlist to be played, run, or displayed by the media player. The media player accesses the stored user identification information of the current user and uses the content object interface 502 to provide the user identification information of the current user to each content object included in the selected playlist. In the example embodiment, the media player is a software media player application that is stored in the storage device 216 of the media server 104 of FIG. 3, for example, as computer-executable process steps encoded in machine-executable instructions. In this case, the processor 212 first loads the computer-executable process steps, encoded in machine-executable instructions, from the storage device 216, or another storage device into a region of the memory 214. The processor 212 can then execute the stored process steps from the memory 214 in order to execute the loaded computer-executable process steps.

In other example embodiments, the media player is stored and executed by an external hardware device, such as, for example, the device 106.

In the case where a selected content object is to be played, run, or displayed, the media player uses the content object interface 502, of the selected content object, to get the corresponding data to be played, run or displayed by the media player. The media player accesses the stored user identification information of the current user and uses the content object interface 502 to provide the user identification information of the current user to the selected content object.

FIG. 6 is a module communication flow diagram for the software architecture shown in FIG. 4. As shown in FIG. 6, the presentation layer module 401 communicates with various functional modules, each of which is responsible for certain functions. The functional modules include a guided browse module 604, a playlist module 609 and a media player module 610.

Generally, the guided browse module 604 generates and manages guided browse functions for content sources. As shown in FIG. 6, guided browse module 604 manages guided browse functions for the following content sources: minims content library 601, Mediaspace module 602, active search module 603, and contents messaging module 605. In the example embodiment, the Mediaspace module 602 manages a plurality of content sources, including an mlight_eds content source 606, an MPV content library 607, and an IMDiscoveiy module 608.

The minims content library (“mimi media server content library”) 601 provides content stored on a mass storage device, such as, for example, a USB memory stick, or the like. The active search module 603 provides content by communicating with a search service via a network. The contents messaging module 605 provides content by communicating with a messaging service via a network. The Mediaspace module 602 provides content from content servers via a network. The mlight_cds (“Mediabolic lightweight content directory service”) content source 606 is a Universal Plug and Play Content Directory Service. The MPV (“Music/Photo/Video”) content library 607 is a content source for audio, still imagery, e-book and video contents. The IMDiscovery module 608 discovers Universal Plug and Play servers on a network.

The presentation layer module 401 communicates with guided browse module 604 in an asynchronous manner. The guided browse module 604 includes a function generation module 612 and one or more guided browse functions 404 that are generated by the function generation module 612. The guided browse module 604 communicates with a plurality of content sources, such as minims content library module 601, Mediaspace module 602, Active Search module 603, and Content Messaging module 605.

The guided browse module 604 communicates with minims content library module 601 and Active Search module 603 in a synchronous manner, and communicates with Mediaspace module 602 and Content Messaging module 605 in an asynchronous manner.

Mediaspace module 602 communicates with mlight_cds module 606 and MPV content library 607 in a synchronous manner, and communicates with IMDiscovery module 608 in an asynchronous manner.

The presentation layer module 401 communicates with playlist module 609 in an asynchronous manner. The playlist module 609 corresponds to playlist interface 501 described in relation to FIG. 5, and represents a playlist that contains one or more content objects.

The presentation layer module 401 communicates with media player module 610 in an asynchronous manner. The media player module 610 corresponds to the media player interface 503 of FIG. 5, and includes the computer-executable process steps, encoded in machine-executable instructions, of the media player. The media player module 610 communicates with playlist module 609 in a synchronous manner. The media player module 610 communicates with the playback manager module 611 in an asynchronous manner.

The media player module 610 provides media playback. For example, the media player module 610 determines what media format is preferred, for example, according to the media player device's compatibility. The media player module 610 switches to a next song in a playlist, handles transition effects, and the like. The playback manager module 611 provides media playback capability such as, for example, decoding video and/or audio codecs, trick mode, controlling the video and/or audio hardware, and the like.

As will be described in more detail below, the function generation module 612 of FIG. 6 generates a guided browse function in response to receiving a content source identifier for the content source, a content type, and a hierarchical structure. The hierarchical structure defines a hierarchy of content stored in the content source that is independent from the file structure of the content stored in the content source. In response to receiving a request from the presentation layer module 401 to browse content corresponding to a selected node in the hierarchical structure, the guided browse function 404 of FIG. 4 searches the content stored in the content source by using a search query corresponding to the selected node, and returns results of the search to the presentation layer module 401 which presents the results to a user. The hierarchical structure is a tree structure, and nodes in the hierarchical structure represent search queries. The content type includes at least one of e-book content, video content, audio content, still imagery, applications, animations, television programs, movies, video recordings, music, audio recordings, podcasts, radio programs, spoken audio, photos, graphics, aggregated content, and native browse. The hierarchical structure includes at least one of a e-book content tree structure, video content tree structure, audio content tree structure, still imagery tree structure, applications tree structure, animations tree structure, television programs tree structure, movies tree structure, video recordings tree structure, music tree structure, audio recordings tree structure, podcasts tree structure, radio programs tree structure, spoken audio tree structure, photos tree structure, and graphics tree structure.

As described above, a hierarchical structure defines a hierarchy of content stored in the content source that is independent from the file structure of the content stored in the content source. FIG. 7A illustrates content arranged in a hierarchical structure, in accordance with an example embodiment in which the hierarchical structure is a music tree structure. As shown in FIG. 7A, the root container node contains an “album” container node, an “artist” container node, an “all tracks” container node, a “recommended” container node, and a “sponsored recommendations” container node. The “album” container node represents a search query for a list of all albums for songs contained in the corresponding content source of the related guided browse function. The “artist” container node represents a search query for a list of all artists for songs contained in the corresponding content source. The “all tracks” container node represents a search query for a list of all songs contained in the corresponding content source. The “recommended” container node represents a search query for all recommended albums contained in the corresponding content source. The “sponsored recommendations” container node represents a search query for all albums, contained in the corresponding content source, that are recommended by a sponsor.

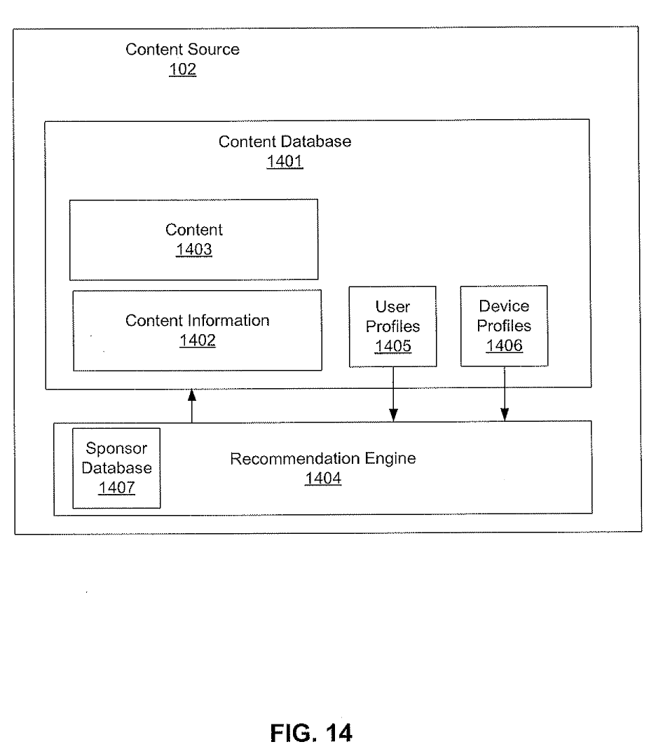

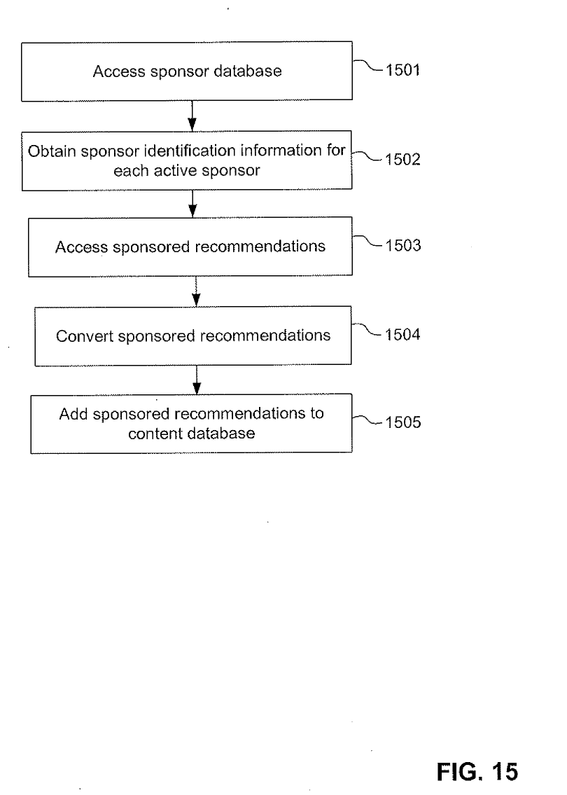

The trees returned from any top level container are known as the result level. As shown in FIG. 7A, the data returned by browsing the “album” top level container node are album container nodes for each album represented in the content source. The data returned by browsing an individual album container are song content objects. Each individual album container node represents a search query for all songs in the content source that are contained in the respective album. The data returned by browsing the “artist” top level container node are artist container nodes for each artist represented in the content source. The data returned by browsing an individual artist container are song content objects. Each individual artist container node represents a search query for all songs in the content source that are related to the respective artist. The data returned by browsing the “all tracks” top level container node are the song content objects contained in the content source. The data returned by browsing the “recommended” top level container node are album container nodes for each recommended album represented in the content source. The data returned by browsing an individual recommended album container are song content objects. Each individual recommended album container node represents a search query for all songs in the content source that are contained in the respective recommended album. The data returned by browsing the “sponsored recommendations” top level container node are sponsor object nodes for names corresponding to sponsors who recommend albums represented in the content source. The data returned by browsing an individual sponsor object are recommended album container nodes for each recommended album represented in the content source. The data returned by browsing an individual recommended album container are song content objects. Each individual sponsor object node represents a search query for all albums in the content source recommended by the respective sponsor. Each individual album container node represents a search query for all songs in the content source that are contained in the respective album. Recommended content will be described below in more detail, with respect to FIGS. 14 and 15.

FIG. 7B illustrates content arranged in a hierarchical structure, in accordance with an example embodiment in which the hierarchical structure is a video content tree structure. As shown in FIG. 7B, the root container node contains a “Movies” container node, a “Television” container node, a “Video Recordings” container node, a “Recommended” container node, and “Sponsored Recommendations” container node. The “Movies” container node represents a search query for a list of all movies contained in the corresponding content source of the related guided browse function. The “Television” container node represents a search query for a list of all television programs contained in the corresponding content source. The “Video Recordings” container node represents a search query for a list of all video recordings contained in the corresponding content source. The “Recommended” container node represents a search query for all recommended video content contained in the corresponding content source. The “Sponsored Recommendations” container node represents a search query for all recommended video content, contained in the corresponding content source, that are recommended by a sponsor.

As shown in FIG. 7B, the data returned by browsing the “Movies” top level container node are movie letter container nodes for letters corresponding to movie names represented in the content source. The data returned by browsing an individual movie letter container are movie content objects. Each individual movie letter container node represents a search query for all movies in the content source whose names start with the letter of the movie letter container node. The data returned by browsing the “Television” top level container node are television letter container nodes for letters corresponding to television program names represented in the content source. The data returned by browsing an individual television letter container are television program content objects. Each individual television letter container node represents a search query for all television program in the content source whose names start with the letter of the television letter container node. The data returned by browsing the “Video Recordings” top level container node are recordings letter container nodes for letters corresponding to video recording names represented in the content source. The data returned by browsing an individual recordings letter container are video recording content objects. Each individual recordings letter container node represents a search query for all video recordings in the content source whose names start with the letter of the recordings letter container node.

The data returned by the “Recommended” top level container node are a “Recommended Movies” container node, a “Recommended Television” container node, and a “Recommended Video Recordings” container node. The data returned by browsing the “Recommended Movies” container node are recommended movie letter container nodes for letters corresponding to recommended movie names represented in the content source. The data returned by browsing an individual recommended movie letter container are recommended movie content objects. Each individual recommended movie letter container node represents a search query for all recommended movies in the content source whose names start with the letter of the recommended movie letter container node. The data returned by browsing the “Recommended Television” container node are recommended television letter container nodes for letters corresponding to recommended television program names represented in the content source. The data returned by browsing an individual recommended television letter container are recommended television program content objects. Each individual recommended television letter container node represents a search query for all recommended television programs in the content source whose names start with the letter of the recommended television letter container node. The data returned by browsing the “Recommended Video Recordings” container node are recommended video recording letter container nodes for letters corresponding to recommended video recording represented in the content source. The data returned by browsing an individual recommended video recording letter container are recommended video recording content objects. Each individual recommended video recording letter container node represents a search query for all recommended video recording in the content source whose names start with the letter of the recommended video recording letter container node.

The data returned by browsing the “sponsored secommendations” top level container node are sponsor object nodes for names corresponding to sponsors recommending video content represented in the content source. The data returned by browsing an individual sponsor object node are movie content objects, television program content objects, and video recording content objects that are recommended by the sponsor. Each individual sponsor object node represents a search query for all movie content objects, television program content objects, and video recording content objects, in the content source, that are recommended by the sponsor. Thus, in the example embodiment shown in FIG. 7B, the “sponsored secommendations” node aggregates recommendations for all video content, namely movies, television programs, and video recordings.

FIG. 7C illustrates content arranged in a hierarchical structure, in accordance with an example embodiment in which the hierarchical structure is a photos tree structure. As shown in FIG. 7C, the root container node contains an “album” container node, a “slideshows” container node, an “all photos” container node, a “recommended” container node, and a “sponsored secommendations” container node. The “album” container node represents a search query for a list of all albums for photos contained in the corresponding content source of the related guided browse function. The “slideshows” container node represents a search query for a list of all slideshows contained in the corresponding content source. The “all photos” container node represents a search query for a list of all photos contained in the corresponding content source. The “recommended” container node represents a search query for recommended photos. The “sponsored secommendations” container node represents a search query for photos, contained in the corresponding content source, that are recommended by a sponsor.

As shown in FIG. 7C, the data returned by browsing the “album” top level container node are album container nodes for each album represented in the content source. The data returned by browsing an individual album container are photo content objects. Each individual album container node represents a search query for all photos in the content source that are contained in the respective album. The data returned by browsing the “slideshows” top level container node are slideshow content objects contained in the content source. The data returned by browsing the “all photos” top level container node are the photo content objects contained in the content source. The data returned by browsing the “recommended” container node are recommended photo content objects contained in the content source. The data returned by browsing the “sponsored secommendations” container node are sponsor object nodes for names corresponding to sponsors recommending photos represented in the content source. The data returned by browsing an individual sponsor object are photo content objects. Each individual sponsor object node represents a search query for all photos in the content source recommended by the sponsor.

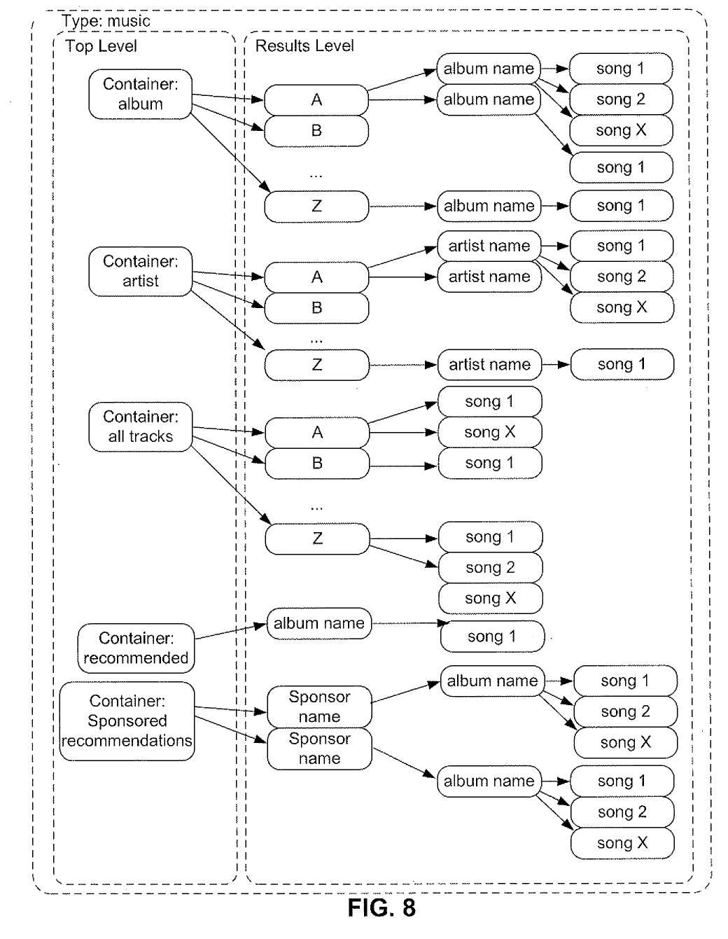

FIGS. 8 to 13 describe an example embodiment in which the content type is a “music” content type and the hierarchical structure is a music tree structure. However, in other example embodiments, the structures, procedures and user interfaces described with respect to FIGS. 8 to 13 can be applied to other content types and other hierarchical structures. For example, the structures, procedures and user interfaces described with respect to FIGS. 8 to 13 can be applied to one or more of video, audio, still imagery, applications, animations, television programs, movies, video recordings, music, audio recordings, podcasts, radio programs, spoken audio, photos, graphics, aggregated content, and the like.

FIG. 8 illustrates content arranged in a hierarchical structure, in accordance with an example embodiment in which the hierarchical structure is a music tree structure. As shown in FIG. 8, the root container node contains an “album” container node, an “artist” container node, an “all tracks” container node, a “recommended” container node, and a “sponsored secommendations” container node. The “album” container node represents a search query for a list of all letters corresponding to album names represented in the content source of the related guided browse function. The “artist” container node represents a search query for a list of all letters corresponding all artists for songs contained in the corresponding content source. The “all tracks” container node represents a search query for a list of all letters corresponding to all songs contained in the corresponding content source. The “recommended” container node represents a search query for all recommended albums contained in the corresponding content source. The “sponsored secommendations” container node represents a search query for all albums, contained in the corresponding content source, that are recommended by a sponsor.

The data returned by browsing the “album” top level container node are container nodes for letters corresponding to album names represented in the content source. The data returned by browsing an individual letter container for the album top level container are album container nodes. Each individual album letter container node represents a search query for all albums in the content source that whose names start with the respective letter. The data returned by browsing an individual album container are song content objects. Each individual album container node represents a search query for all songs in the content source that are contained in the respective album.

The data returned by browsing the “artist” top level container node are container nodes for letters corresponding to artist container nodes for each artist represented in the content source. The data returned by browsing an individual letter Container for the artist top level container are artist container nodes. Each individual artist letter container node represents a search query for all artists in the content source whose names start with the respective letter. The data returned by browsing an individual artist container are song content objects. Each individual artist container node represents a search query for all songs in the content source that are related to the respective artist.

The data returned by browsing the “all tracks” top level container node are container nodes for letters corresponding to the song content objects contained in the content source. The data returned by browsing an individual letter container for the “all tracks” top level container are song content objects. Each individual song letter container node represents a search query for all songs in the content source whose names start with the respective letter.

The data returned by browsing the “recommended” top level container node are album container nodes for each recommended album represented in the content source. The data returned by browsing an individual recommended album container are song content objects. Each individual album container node represents a search query for all songs in the content source that are contained in the respective album.

The data returned by browsing the “sponsored secommendations” top level container node are sponsor object nodes for names corresponding to sponsors recommending albums represented in the content source. The data returned by browsing an individual sponsor object are album container nodes for each recommended album represented in the content source. The data returned by browsing an individual recommended album container are song content objects. Each individual sponsor object node represents a search query for all albums in the content source recommended by the sponsor. Each individual album container node represents a search query for all songs in the content source that are contained in the respective album.

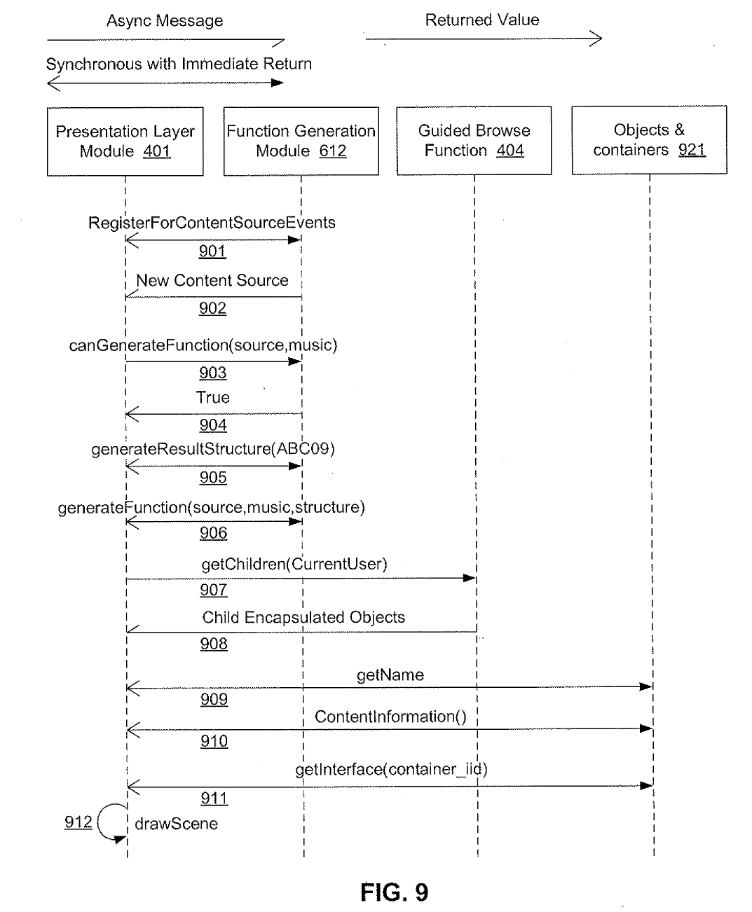

FIG. 9 is a sequence diagram for explaining an example procedure for browsing content stored in a content source. As shown at a step 901, the presentation layer module 401 of FIG. 4 registers for content source events with a function generation module 612 to find all content sources on network 112, or coupled to the media server 104 of FIGS. 1 and 3 via multimedia signal lines 130, 230, and/or 330 of FIGS. 1, 2 and 3, respectively. In the example embodiment, the content sources are UPnP (Universal Plug and Play) and/or DLNA (digital living network alliance) type servers, and content sources are discovered by using these protocols.

UPnP is a set of networking protocols promulgated by the UPnP Forum. The goals of UPnP are to allow devices to couple seamlessly and to simplify the implementation of networks for data sharing, communications, and entertainment, and in corporate environments for simplified installation of computer components. UPnP achieves this by defining and publishing UPnP device control protocols (DCP) built upon open, Internet-based communication standards. The term UPnP is derived from plug-and-play, a technology for dynamically attaching devices to a computer, although UPnP is not directly related to the earlier plug-and-play technology. UPnP devices are “plug-and-play” in that when coupled to a network they automatically announce their network address and supported device and services types, enabling clients that recognize those types to use the device. See <http://en.wikipedia.org/wiki/Upnp>, the entire contents of which are incorporated by reference as if set forth in full herein.

DLNA (Digital Living Network Alliance) is a standard used by manufacturers of consumer electronics to allow entertainment devices to share their content with each other across a home network. DLNA provides for the use of digital media between different consumer electronic devices. For example, a DLNA compliant TV will interoperate with a DLNA compliant PC to play music, photos or videos. The specification also includes DRM (digital rights management). See <http://en.wikipedia.org/wiki/Dlna>, the entire contents of which are incorporated by reference as if set forth in full herein.

Regardless of the particular protocol used, at block 902 of FIG. 9, the presentation layer module 401 receives an asynchronous event notification indicating that a new content source has become available. In a case where a previously available content source becomes unavailable, the presentation layer module 401 receives an asynchronous event notification indicating that the previously available content source has become unavailable.

Example content sources include a Universal Plug and Play Content Directory Service (“UPnP CDS”), a local content library, a mimims content library and external content provider, and an aggregated content provider. External content providers include, for example, Internet content providers such as www.Youtube.com and the like, and television content providers such as CBS and the like. Aggregated content providers include content providers that aggregate information from different content providers. For example, an aggregated content provider can provide content from different external content providers, such as, for example, content from www.Netflix.com and content from www.Blockbuster.com.

As shown at block 903, the presentation layer module 401 selects a content source and a content type, and asks the function generation module 612 to determine whether the selected content source supports search functionality for the selected content type. Example search functionality include UPnP Search, DLNA type search, or another type of search functionality. In other words, presentation layer module 401 asks the function generation module 612 to determine whether the selected content source supports a guided browse function of the received content type, such that the guided browse function provides browsing of the selected content type in accordance with a hierarchical structure of content stored in the content source, the hierarchical structure being independent from the file structure of the content stored in the content source.

As shown at block 904, the presentation layer module 401 receives a response from the function generation module 612 which indicates that the selected content source supports search functionality for the selected content type, and thus supports a guided browse function that provides browsing in accordance with the hierarchical structure.

As shown at block 905, the presentation layer module 401 asks the function generation module 612 to generate the hierarchical structure to be used by the guided browse function to browse content stored in the content source. In the example embodiment illustrated in FIG. 9, the hierarchical structure generated at the block 905 corresponds to the hierarchical structure described above with respect to FIG. 8.

As shown at block 906, the presentation layer module 401 invokes a generateFunction( ) module provided by the function generation module 612 to generate the guided browse function 404. The generateFunction( ) module takes as inputs a content source identifier for the selected content source, a content type, and a hierarchical structure.

In the example embodiment, the function generation module 612's generateFunction( ) module is stored as computer-executable process steps encoded in machine-executable instructions. The computer-executable process steps are for generating the guided browse function 404. The computer-executable process steps of the generateFunction( ) module are stored in storage device 216 of the media server 104 of FIG. 1 and FIG. 3. The computer-executable process steps of the generateFunction( ) module are executed by the processor 212 of the media server 104 of FIG. 1 and FIG. 3.

In other embodiments, the generateFunction( ) module is a hardware device that includes electronic circuitry constructed to generate the guided browse function 404. In an example embodiment in which the function generation module 612 is a hardware device, the generateFunction( ) module is electronic circuitry that is included in the function generation module 612 hardware device. However, in other embodiments, the function generation module 612 and the generateFunction( ) module are separate hardware devices. In an example embodiment, the electronic circuitry includes special purpose processing circuitry. In other example embodiments, the electronic circuitry includes at least one general purpose processor that is constructed to execute computer-executable process steps encoded in machine-executable instructions that are stored on a computer-readable storage medium of the hardware device.

It should be understood that in various embodiments both the function generation module 612 and the generateFunction( ) module are hardware devices. In other embodiments, the function generation module 612 is a hardware device and the generateFunction( ) module is computer-executable process steps stored on a computer-readable storage medium. In other embodiments, the function generation module 612 is computer-executable process steps stored on a computer-readable storage medium, and the generateFunction( ) module is a hardware device. In other embodiments, both the function generation module 612 and generateFunction( ) module are computer-executable process steps stored at least one computer-readable storage medium.

As shown in the example embodiment illustrated in FIG. 9, the source identifier identifies the selected content source, the content type is a “music” content type, and the structure is the structure generated at the block 905. In other embodiments, the content type can be e-book content, video content, audio content, still imagery, applications, animations, television programs, movies, video recordings, music, audio recordings, podcasts, radio programs, spoken audio, photos, graphics, aggregated content, or native browse.

In other embodiments, the hierarchical structure can be an e-book content tree structure, video content tree structure, audio content tree structure, still imagery tree structure, applications tree structure, animations tree structure, television programs tree structure, movies tree structure, video recordings tree structure, music tree structure, audio recordings tree structure, podcasts tree structure, radio programs tree structure, spoken audio tree structure, photos tree structure; or graphics tree structure.

After the guided browse function 404 has been generated, event notifications are sent to the presentation layer 401. The event notifications comply with one or more protocols such as UPnP, DLNA, and/or another protocol. The event notifications contain the root container object of the guided browse function 404. The root container object includes the top level contents of the content source represented by the guided browse function 404. In particular, the root container object contains the top level container objects such as top level nodes in the hierarchical structure. In the example embodiment of FIG. 9, the top level container objects are “album”, “artist”, “all tracks”, “recommended”, and “sponsored recommendations”. The presentation layer 401 displays the names of the top level container objects in a manner such that they are selectable by a user.

As shown at block 907, the presentation layer 401 detects user selection of a top level container object, and calls the getChildren( ) module provided by the guided browse interface 504 to ask the guided browse function 404 for the list children, or contents, of the selected top level container object such as, for example, top level nodes in the hierarchical structure. The presentation layer 401 accesses the stored user identification information of the current user, and specifies the user identification information of the current user when invoking the getChildren( ) module. As shown at block 908, the presentation layer 401 asynchronously receives the list of child objects 921. As shown at block 909, for each received child object, the presentation layer 401 invokes the getName( ) module of the child object to get the name of the child object 921, and at block 910 the presentation layer 401 invokes the ContentInformation( ) module to get any content information represented by the child object 921.

As shown at block 911, for each child object 921, the presentation layer 401 invokes the getInterface( ) module of the child object to determine whether the child object is a container object or a content object. If the getInterface( ) module returns a container object interface, then the child is a container object. If the getInterface( ) module returns a content object interface, then the child is a content object.

As shown at block 912, the presentation layer 401 displays the names of the child objects in a manner such that they are selectable by a user, and also displays content information for the child objects. In an example embodiment, the content information includes displayed names of related or recommended content, the displayed names being selectable by a user. In a case where a displayed name of an item is selected, the presentation layer 401 determines whether the object corresponding to the selected item is a container object or a content object, by using the getInterface( ) module.

In a case where the item corresponds to a container object, the presentation layer 401 invokes the getChildren( ) module of the guided browse interface 504 to ask the guided browse function 404 for the list of children, or contents, of the selected container object. The presentation layer 401 accesses the stored user identification information of the current user, and specifies the user identification information of the current user when invoking the getChildren( ) module. For each child object, the presentation layer 401 invokes the getName( ) module of the child object's interface to get the name of the child object 921, and displays the names of the child objects in a manner such that they are selectable by a user. For each child object, the presentation layer 401 also invokes the ContentInformation( ) module to get any content information represented by the child object 921.

In a case where the item corresponds to a content object, the presentation layer 401 determines the type of the content object, such as e-book content, video content, audio content, still imagery, applications, animations, etc., and generates the appropriate type of media player for the type of content, then enqueues the item for playback by the media player. When the media player is playing, running, or displaying items, it sends playback status events to the presentation layer 401, which displays the status to the user. The media player accesses the stored user identification information of the current user and uses the content object interface 502 to provide the user identification information of the current user to the content object that corresponds to the selected item.

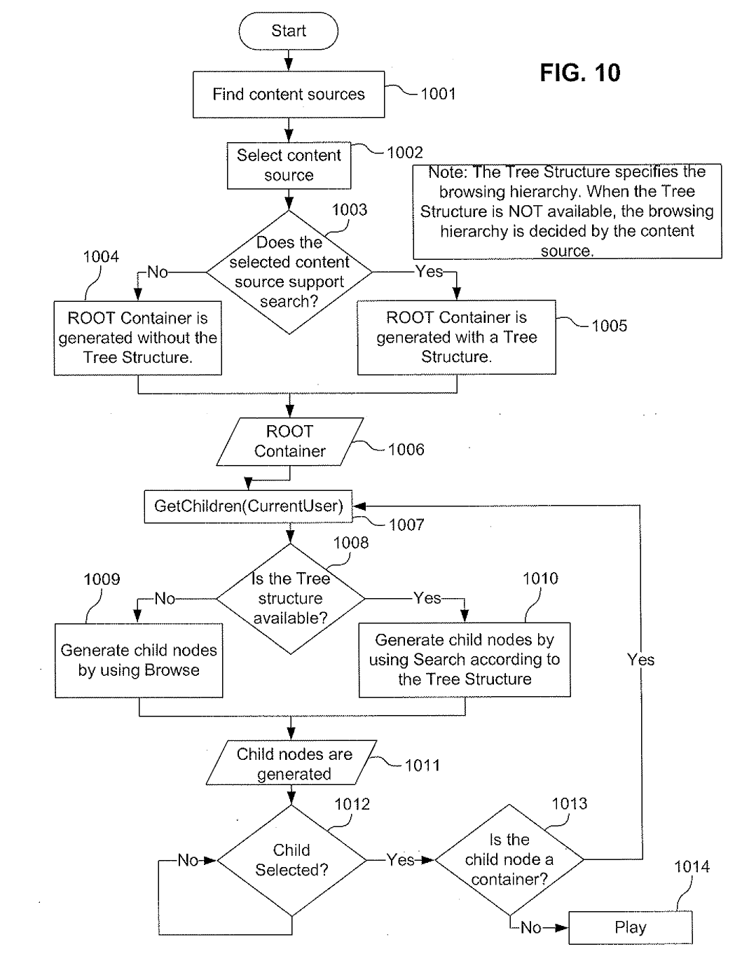

FIG. 10 is a flowchart diagram for explaining an example procedure for browsing content stored in a content source. At block 1001, presentation layer module 401 of FIG. 5 finds all available content sources, as described above with respect to FIG. 9. At block 1002, presentation layer module 401 of FIG. 5 selects a content source and a content type, as described above with respect to FIG. 9. At block 1003, presentation layer module 401 of FIG. 5 asks function generation module 612 of FIG. 6 to determine whether the selected content source supports search for the selected content type, such as, for example, UPnP and/or DNLA search. In other words, presentation layer module 401 asks the function generation module 612 to determine whether the selected content source supports a guided browse function of the received content type, such that the guided browse function provides browsing of the selected content type in accordance with a hierarchical structure of content stored in the content source, the hierarchical structure being independent from the file structure of the content stored in the content source.

If presentation layer module 401 receives a response from function generation module 612 which indicates that the selected content source does not support search for the selected content type (“No” at block 1003), processing proceeds to block 1004. In this case, the content source does not support a guided browse function that provides browsing in accordance with the hierarchical structure. Accordingly, at block 1004, the presentation layer module 401 invokes the generateFunction( ) module provided by the function generation module 612 to generate the guided browse function. In this case, the generateFunction( ) module takes as inputs a content source identifier for the selected content source, and a native browse content type. Because the guided browse function has the native browse content type, any hierarchical structure input is ignored. The hierarchical structure is not used in the case a guided browse function having the native browse content type because such a guided browse function returns the content stored in the content source according to the file structure of the content stored in the content source. As with other types of guided browse functions, the guided browse function having the native browse content type returns content to the presentation layer module 401 asynchronously.

If the presentation layer module 401 receives a response from function generation module 612 which indicates that the selected content source does support search for the selected content type (“Yes” at block 1003), processing proceeds to block 1005. In this case, the guided browse function is generated as described above with respect to FIG. 9.

At block 1006, the guided browse function sends notification events to the presentation layer 401. The notification events contain the root container object of the guided browse function.

At block 1007, the presentation layer 401 detects user selection of a top level container object, and invokes the getChildren( ) module of the guided browse interface to ask the guided browse function for the list of children, or contents, of the selected top level container object. The presentation layer 401 accesses the stored user identification information of the current user, and specifies the user identification information of the current user when invoking the getChildren( ) module. In response to receiving the call to the getChildren( ) module, at block 1008, the guided browse function determines whether the guided browse function has a native browse type, meaning that it is in the native browse mode. In other words, the guided browse function determines whether a hierarchical tree structure is available.

If the guided browse function determines that the guided browse function has a native browse type (“No” at block 1008), then at block 1009, the guided browse function uses a browse functionality of the content source to generate the child nodes which are the results to be returned to the presentation layer module 401. In the example embodiment described with respect to FIG. 10, the guided browse function browses the content source by using browse functionality of the content source, such as, for example UPnP Browse, DNLA type browse, or another type of browse functionality.

If the guided browse function determines that the guided browse function does not have a native browse type (“No” at block 1008), then at block 1010, the guided browse function uses a search functionality of the content source to generate the child nodes which are the results to be returned to presentation layer module 401. The child nodes are generated by searching the content source according to the hierarchical tree structure of the guided browse function. In particular, the guided browse function searches the content stored in the content source by using a search query corresponding to the selected top level container object. The search query is defined by the hierarchical tree structure of the guided browse function. In the example embodiment described with respect to FIG. 10, the guided browse function searches the content source by using search functionality such as, for example, UPnP Search, DLNA type search, or another type of search functionality.

Terms of the search query are added to a browse history of a user profile associated with the user identification information of the current user.

At block 1011, the guided browse function sends notification events to the presentation layer module 401. The notification events contain the generated child nodes, which can be either container objects or content objects. The generated child notes, which are the result of the browse or search operation, are sent to the presentation layer module 401 in an asynchronous manner. The presentation layer module 401 displays the names of received child nodes, or items, and any related content information, as described above with respect to FIG. 9.

At block 1012, the presentation layer module 401 detects user selection of a displayed child node. In response to detection of user selection of a displayed child node, (“Yes” at block 1012), processing proceeds to block 1013. At block 1013, the presentation layer 401 determines whether a selected child node is a container object or a content object, by using the getInterface( ) module.

In a case where the selected child node is a content object (“No” at block 1013), processing proceeds to block 1014, where the presentation layer 401 determines the type of the content object, such as e-book content, video content, audio content, still imagery, applications, animations, etc., and generates the appropriate type of media player far the type of content, then enqueues the item for playback by the media player. The media player plays the content represented by the content object by accessing the corresponding content source. The media player accesses the stored user identification information of the current user and uses the content object interface 502 to provide the user identification information of the current user to the content object that corresponds to the selected item.

In a case where the selected child node is a container object (“Yes” at block 1013), processing returns to block 1007, where the presentation layer 401 invokes the getChildren( ) module of the guided browse interface to ask the guided browse function for the list of children, or contents, of the selected container object. If the content type of the guided browse function is native browse and the content source is UPnP CDS, the guided browse function sends the presentation layer module 401 asynchronous updates for each UPnP container object referenced by the presentation layer module 401. UPnP content directory services are discussed above in relation to FIG. 9.

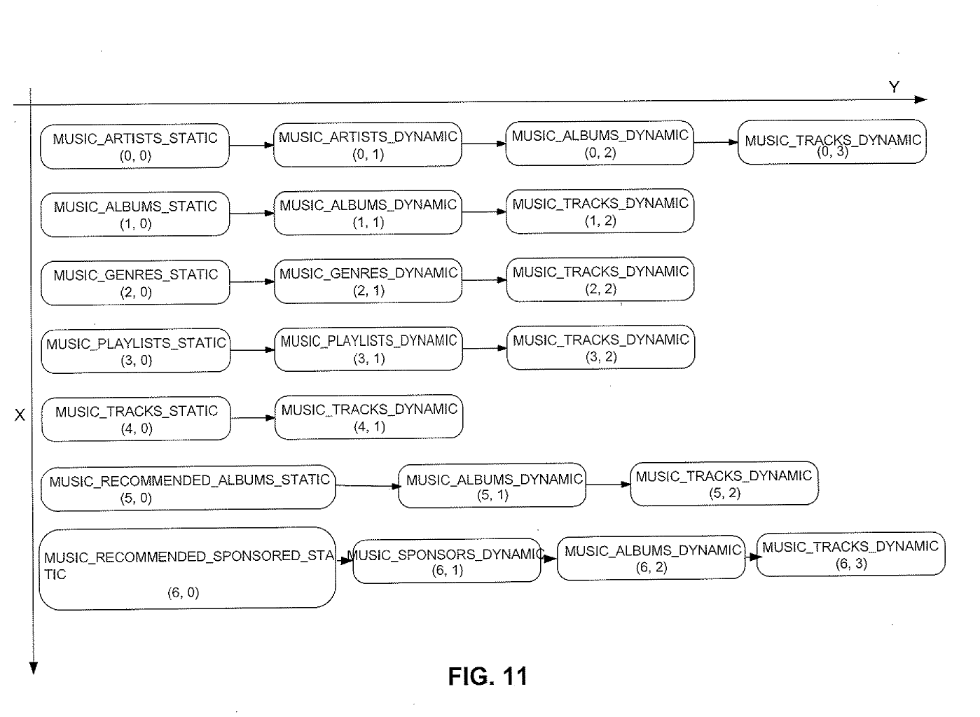

FIG. 11 illustrates a hierarchical tree structure used to generate a guided browse function, in accordance with an example embodiment in which the hierarchical structure is a music tree structure. In other embodiments, the hierarchical tree structure can represent one or more of e-book content, video content, audio content, still imagery, applications, animations, and the like. The hierarchical tree structure represents a hierarchy of nodes in a content tree.

The nodes correspond to at least one query. Exemplary queries corresponding to the nodes of the hierarchical tree structure include the following: a query for all music artists represented by the content stored in the content source; a query for all music albums represented by the content stored in the content source; a query for all music genres represented by the content stored in the content source; a query for all music playlists represented by the content stored in the content source; a query for all music tracks represented by the content stored in the content source; a query for all photo albums represented by the content stored in the content source; a query for all photo slideshows represented by the content stored in the content source; a query for all photos represented by the content stored in the content source; a query for all video playlists represented by the content stored in the content source; a query for all video clips represented by the content stored in the content source; a query for content matching a selected music artist; a query for content matching a selected music album; a query for content matching a selected music genre; a query for content matching a selected music playlist; a query for content matching a selected music track; a query for content matching a selected photo album; a query for content matching a selected photo slideshow; a query for content matching a selected photo; a query for content matching a selected video playlist; a query for content matching a selected video clip; a query for all video content represented by the content stored in the content source; a query for all audio content represented by the content stored in the content source; a query for all still imagery represented by the content stored in the content source; a query for all applications represented by the content stored in the content source; a query for all animations represented by the content stored in the content source; a query for all games represented by the content stored in the content source; a query for all television programs represented by the content stored in the content source; a query for all movies represented by the content stored in the content source; a query for all video recordings represented by the content stored in the content source; a query for all music represented by the content stored in the content source; a query for all audio recordings represented by the content stored in the content source; a query for all podcasts represented by the content stored in the content source; a query for all radio programs represented by the content stored in the content source; a query for all spoken audio represented by the content stored in the content source; a query for all photos represented by the content stored in the content source; a query for all graphics represented by the content stored in the content source; a query for all meta tags represented by the content stored in the content source; a query for all dates represented by the content stored in the content source; a query for content matching a selected meta tag; a query for content matching a selected date; a query for content matching a selected movie; a query for content matching a selected television program; a query for content matching a selected video content; a query for content matching a selected audio content; a query for content matching a selected still image; a query for content matching a selected application; a query for content matching a selected animation; a query for content matching a selected video recording; a query for content matching a selected audio recording; a query for content matching a selected podcast; a query for content matching a selected radio program; a query for content matching a selected spoken audio; a query for content matching a selected game; a query for content matching a selected music track; a query for content matching a selected music album; a query for content matching a selected music artist; a query for content matching a selected graphic; a query for content matching a selected photo; a query for all actors represented by the content stored in the content source; a query for all directors represented by the content stored in the content source; a query for all genres represented by the content stored in the content source; a query for content stored in the content source that matches a current user; a query for all new content stored in the content source; a query for all high definition content stored in the content source; a query for favorite content stored in the content source; a query for content matching a selected actor; a query for content matching a selected director; a query for content matching a selected run time; a query for content matching a selected MPAA (Motion Picture Academy of America) rating; and a query for content matching a selected review rating; a query for television episodes matching a selected television program; a query for content matching a selected television episode; a query for photos matching a selected content; a query for video clips matching a selected content; a query for audio clips matching a selected content; a query for content matching a selected content; a query for video content matching a selected content; a query for audio content matching a selected content; a query for still imagery matching a selected content; a query for applications matching a selected content; a query for animations matching a selected content; a query for games matching a selected content; a query for television programs matching a selected content; a query for movies matching a selected content; a query for video recordings matching a selected content; a query for music matching a selected content; a query for audio recordings matching a selected content; a query for podcasts matching a selected content; a query for radio programs matching a selected content; a query for spoken audio matching a selected content; a query for photos matching a selected content; a query for graphics matching a selected content; a query for awards matching a selected content; a query for cast and crew matching a selected content; a query for actors matching a selected content; a query for directors matching a selected content; a query for synopsis matching a selected content; a query for biographies matching a selected content; a query for credits matching a selected content; a query for meta tags matching a selected content, a query for all container objects matching a selected content; a query for all e-books represented by the content stored in the content source; a query for all audiobooks represented by content stored in the content source; a query for all content matching a selected author; a query for all content matching a selected publisher; a query for all content matching a selected e-book; a query for all content matching a selected audiobook; a query for all content matching a selected speaker; a query for all speakers represented by the content stored in the content source; a query for all e-books matching a selected content; a query for all audiobooks matching a selected content; a query for authors matching a selected content; a query for publishers matching a selected content; and a query for speakers matching a selected content.

Further exemplary queries corresponding to the nodes of the hierarchical tree structure include the following: a query for all recommended music artists represented by the content stored in the content source; a query for all recommended music albums represented by the content stored in the content source; a query for all recommended music genres represented by the content stored in the content source; a query for all recommended music playlists represented by the content stored in the content source; a query for all recommended music tracks represented by the content stored in the content source; a query for all recommended photo albums represented by the content stored in the content source; a query for all recommended photo slideshows represented by the content stored in the content source; a query for all recommended photos represented by the content stored in the content source; a query for all recommended video playlists represented by the content stored in the content source; a query for all recommended video clips represented by the content stored in the content source; a query for recommended content matching a selected music artist; a query for recommended content matching a selected music album; a query for recommended content matching a selected music genre; a query for recommended content matching a selected music playlist; a query for recommended content matching a selected music track; a query for recommended content matching a selected photo album; a query for recommended content matching a selected photo slideshow; a query for recommended content matching a selected photo; a query for recommended content matching a selected video playlist; a query for recommended content matching a selected video clip; a query for all recommended video content represented by the content stored in the content source; a query for all recommended audio content represented by the content stored in the content source; a query for all recommended still imagery represented by the content stored in the content source; a query for all recommended applications represented by the content stored in the content source; a query for all recommended animations represented by the content stored in the content source; a query for all recommended games represented by the content stored in the content source; a query for all recommended television programs represented by the content stored in the content source; a query for all recommended movies represented by the content stored in the content source; a query for all recommended video recordings represented by the content stored in the content source; a query for all recommended music represented by the content stored in the content source; a query for all recommended audio recordings represented by the content stored in the content source; a query for all recommended podcasts represented by the content stored in the content source; a query for all recommended radio programs represented by the content stored in the content source; a query for all recommended spoken audio represented by the content stored in the content source; a query for all recommended photos represented by the content stored in the content source; a query for all recommended graphics represented by the content stored in the content source; a query for all recommended meta tags represented by the content stored in the content source; a query for all recommended dates represented by the content stored in the content source; a query for recommended content matching a selected meta tag; a query for recommended content matching a selected date; a query for recommended content matching a selected movie; a query for recommended content matching a selected television program; a query for recommended content matching a selected video content; a query for recommended content matching a selected audio content; a query for recommended content matching a selected still image; a query for recommended content matching a selected application; a query for recommended content matching a selected animation; a query for recommended content matching a selected video recording; a query for recommended content matching a selected audio recording; a query for recommended content matching a selected podcast; a query for recommended content matching a selected radio program; a query for recommended content matching a selected spoken audio; a query for recommended content matching a selected game; a query for recommended content matching a selected music track; a query for recommended content matching a selected music album; a query for recommended content matching a selected music artist; a query for recommended content matching a selected graphic; a query for recommended content matching a selected photo; a query for all recommended actors represented by the content stored in the content source; a query for all recommended directors represented by the content stored in the content source; a query for all recommended genres represented by the content stored in the content source; a query for recommended content stored in the content source that matches a current user; a query for all recommended new content stored in the content source; a query for all recommended high definition content stored in the content source; a query for favorite content stored in the content source; a query for recommended content matching a selected actor; a query for recommended content matching a selected director; a query for recommended content matching a selected run time; a query for recommended content matching a selected MPAA (Motion Picture Academy of America) rating; and a query for recommended content matching a selected review rating; a query for recommended television episodes matching a selected television program; a query for recommended content matching a selected television episode; a query for recommended photos matching a selected content; a query for recommended video clips matching a selected content; a query for recommended audio clips matching a selected content; a query for recommended content matching a selected content; a query for recommended video content matching a selected content; a query for recommended audio content matching a selected content; a query for recommended still imagery matching a selected content; a query for recommended applications matching a selected content; a query for recommended animations matching a selected content; a query for recommended games matching a selected content; a query for recommended television programs matching a selected content; a query for recommended movies matching a selected content; a query for recommended video recordings matching a selected content; a query for recommended music matching a selected content; a query for recommended audio recordings matching a selected content; a query for recommended podcasts matching a selected content; a query for recommended radio programs matching a selected content; a query for recommended spoken audio matching a selected content; a query for recommended photos matching a selected content; a query for recommended graphics matching a selected content; a query for recommended awards matching a selected content; a query for recommended cast and crew matching a selected content; a query for recommended actors matching a selected content; a query for recommended directors matching a selected content; a query for recommended synopsis matching a selected content; a query for recommended biographies matching a selected content; a query for recommended credits matching a selected content; a query for recommended meta tags matching a selected content, a query for all recommended container objects matching a selected content; a query for all recommended content matching a selected author, a query for all recommended e-books represented by the content stored in the content source; a query for all recommended audiobooks represented by content stored in the content source; a query for all recommended content matching a selected author; a query for all recommended content matching a selected publisher; a query for all recommended content matching a selected e-book; a query for all recommended content matching a selected audiobook; a query for all recommended content matching a selected speaker; a query for all recommended speakers represented by the content stored in the content source; a query for all recommended e-books matching a selected content; a query for all recommended audiobooks matching a selected content; a query for recommended authors matching a selected content; a query for recommended publishers matching a selected content; and a query for recommended speakers matching a selected content.

In an example embodiment, queries corresponding to the nodes of the hierarchical tree structure include the following; a query for all sponsors that recommend content stored in the content source; a query for recommended photos matching a selected sponsor; a query for recommended video clips matching a selected sponsor; a query for recommended audio clips matching a selected sponsor; a query for recommended content matching a selected sponsor; a query for recommended video content matching a selected sponsor; a query for recommended audio content matching a selected sponsor; a query for recommended still imagery matching a selected sponsor; a query for recommended applications matching a selected sponsor; a query for recommended animations matching a selected sponsor; a query for recommended games matching a selected sponsor; a query for recommended television programs matching a selected sponsor; a query for recommended movies matching a selected sponsor; a query for recommended video recordings matching a selected sponsor; a query for recommended music matching a selected sponsor; a query for recommended audio recordings matching a selected sponsor; a query for recommended podcasts matching a selected sponsor; a query for recommended radio programs matching a selected sponsor; a query for recommended spoken audio matching a selected sponsor; a query for recommended photos matching a selected sponsor; a query for recommended graphics matching a selected sponsor; a query for recommended awards matching a selected sponsor; a query for recommended cast and crew matching a selected sponsor; a query for recommended actors matching a selected sponsor; a query for recommended directors matching a selected sponsor; a query for recommended synopsis matching a selected sponsor; a query for recommended biographies matching a selected sponsor; a query for recommended credits matching a selected sponsor; a query for recommended meta tags matching a selected sponsor, a query for all recommended container objects matching a selected sponsor; a query for all recommended content matching a selected author, a query for all recommended e-books represented by the content stored in the content source; a query for all recommended audiobooks represented by content stored in the content source; a query for all recommended content matching a selected author; a query for all recommended content matching a selected publisher; a query for all recommended content matching a selected e-book; a query for all recommended content matching a selected audiobook; a query for all recommended content matching a selected speaker; a query for all recommended speakers represented by the content stored in the content source; a query for all recommended e-books matching a selected sponsor; a query for all recommended audiobooks matching a selected sponsor; a query for recommended authors matching a selected sponsor; a query for recommended publishers matching a selected sponsor; and a query for recommended speakers matching a selected sponsor.

A guided navigation feature for an electronic and/or interactive media guidance module uses the hierarchy of nodes structure to keep track of the footprints in the tree. The basic unit of the hierarchical tree structure is a tree node. The tree nodes are application specific and can be utilized as a building block to make a tree structure.

The tree nodes of the hierarchical tree structure include nodes for at least one of e-book content, video content, audio content, still imagery, applications, and animations. Thus, the queries corresponding to the nodes of the hierarchical tree structure include queries for at least one of e-book content, video content, audio content, still imagery, applications, animations, and the like. The following table lists the possible node types for an example embodiment.

TABLE 1
tree node types

| Type | Description |
|---|---|
| MUSIC_ARTISTS_STATIC | Static node of “Artists”; |
| | associated with a query for all |
| | music artists represented by |
| | the content stored in the |
| | content source |
| MUSIC_ALBUMS_STATIC | Static node of “Albums”; |
| | associated with a query for all |
| | music albums represented by |
| | the content stored in the |
| | content source |
| MUSIC_GENRE_STATIC | Static node of “Genre”; |
| | associated with a query for all |
| | music genres represented by |
| | the content stored in the |
| | content source |
| MUSIC_PLAYLISTS_STATIC | Static node of “Playlists”; |
| | associated with a query for all |
| | music playlists represented |
| | by the content stored in the |
| | content source |
| MUSIC_TRACKS_STATIC | Static node of “All Tracks”; |
| | associated with a query for all |
| | music tracks represented by |
| | the content stored in the |
| | content source |
| MUSIC_ARTISTS_DYNAMIC | Represents search results that |
| | includes music artists [Abba, |
| | Beatles . . .]; |
| MUSIC_ALBUMS_DYNAMIC | Represents search results that |
| | includes music albums [Lost |
| | Highway, Play . . .] |
| MUSIC_GENRES_DYNAMIC | Represents search results that |
| | includes genres [Jazz, Pop, |
| | Rock . . .] |
| MUSIC_PLAYLISTS_DYNAMIC | Represents search results that |
| | includes music playlists [My |
| | Favorite, Dad's collection . . .] |
| MUSIC_TRACKS_DYNAMIC | Represents search results that |
| | includes tracks[Summertime, |
| | Any Other Fool . . .] |
| PHOTO_ALBUMS_STATIC | Associated with a query for |
| | all photo albums represented |
| | by the content stored in the |
| | content source |
| PHOTO_SLIDESHOWS_STATIC | Associated with a query for |
| | all photo slideshows |
| | represented by the content |
| | stored in the content source |
| PHOTO_STATIC | Associated with a query for |
| | all photos represented by the |
| | content stored in the content |
| | source |
| PHOTO_ALBUMS_DYNAMIC | Represents search results that |
| | includes photo albums |
| PHOTO_SLIDESHOWS_DYNAMIC | Represents search results that |
| | includes photo slideshows |
| PHOTO_DYNAMIC | Represents search results that |
| | includes photos |
| VIDEO_PLAYLISTS_STSTIC | Associated with a query for |
| | all video playlists represented |
| | by the content stored in the |
| | content source |
| VIDEO_CLIPS_STATIC | Associated with a query for |
| | all video clips represented by |
| | the content stored in the |
| | content source |
| VIDEO_PLAYLISTS_DYNAMIC | Represents search results that |
| | includes video playlists |
| VIDEO_CLIPS_DYNAMIC | Represents search results that |
| | includes video clips |
| E_BOOKS_STATIC | Associated with a query for |
| | all e-books represented by the |
| | content stored in the content |
| | source |
| AUDIOBOOKS_STATIC | Associated with a query for |
| | all audiobooks represented by |
| | the content stored in the |
| | content source |
| E_BOOKS_AUTHORS_STATIC | Static node of “Authors”; |
| | associated with a query for all |
| | e-book authors represented |
| | by the content stored in the |
| | content source |
| E_BOOKS_BOOKLISTS_STATIC | Static node of “Booklists”; |
| | associated with a query for all |
| | e e-book booklists |
| | represented by the content |
| | stored in the content source |
| E_BOOKS_GENRE_STATIC | Static node of “Genre”; |
| | associated with a query for all |
| | e-book genres represented by |
| | the content stored in the |
| | content source |
| E_BOOKS_PUBLISHERS_STATIC | Static node of “Publisher”; |
| | associated with a query for all |
| | e-book publishers represented |
| | by the content stored in the |
| | content source |
| E_BOOKS_AUTHORS_DYNAMIC | Represents search results that |
| | includes e-book authors |
| E_BOOKS_BOOKLISTS_DYNAMIC | Represents search results that |
| | includes e-book booklists |
| E_BOOKS_GENRES_DYNAMIC | Represents search results that |
| | includes e-book genres |
| E_BOOKS_PUBLISHERS_DYNAMIC | Represents search results that |
| | includes e-book publishers |
| AUDIOBOOKS_AUTHORS_STATIC | Static node of “Authors”; |
| | associated with a query for all |
| | authors represented by the |
| | content stored in the content |
| | source |
| AUDIOBOOKS_BOOKLISTS_STATIC | Static node of “Booklists”; |
| | associated with a query for all |
| | e audiobook booklists |
| | represented by the content |
| | stored in the content source |
| AUDIOBOOKS_GENRE_STATIC | Static node of “Genre”; |
| | associated with a query for all |
| | audiobook genres represented |
| | by the content stored in the |
| | content source |
| AUDIOBOOKS_AUTHORS_DYNAMIC | Represents search results that |
| | includes audiobook authors |
| AUDIOBOOKS_BOOKLISTS_DYNAMIC | Represents search results that |
| | includes audiobook booklists |
| AUDIOBOOKS_GENRES_DYNAMIC | Represents search results that |
| | includes audiobook genres |
| AUDIOBOOKS_PUBLISHERS_STATIC | Static node of “Publisher”; |
| | associated with a query for all |
| | audiobook publishers |
| | represented by the content |
| | stored in the content source |
| AUDIOBOOKS_PUBLISHERS_DYNAMIC | Represents search results that |
| | includes audiobook |
| | publishers |
| MUSIC_RECOMMENDED_ALBUMS_STATIC | Static node of |
| | “Recommended”; associated |
| | with a query for all |
| | recommended music albums |
| | represented by the content |
| | stored in the content source |
| PHOTO_RECOMMENDED_STATIC | Associated with a query for |
| | all recommended photos |
| | represented by the content |
| | stored in the content source |
| VIDEO_RECOMMENDED_CLIPS_STATIC | Associated with a query for |
| | all recommended video clips |
| | represented by the content |
| | stored in the content source |
| E_BOOKS_RECOMMENDED_STATIC | Associated with a query for |
| | all recommended e-books |
| | represented by the content |
| | stored in the content source |
| AUDIOBOOKS_RECOMMENDED_STATIC | Associated with a query for |
| | all recommended audiobooks |
| | represented by the content |
| | stored in the content source |
| MUSIC_RECOMMENDED_SPONSORED_STATIC | Static node of “Sponsored |
| | Recommendations”; |
| | associated with a query for all |
| | sponsors recommending |
| | music content represented by |
| | the content stored in the |
| | content source |
| MUSIC_SPONSORS_DYNAMIC | Represents search results that |
| | includes sponsors of the |
| | current user that are |
| | recommending music content |
| PHOTO_RECOMMENDED_SPONSORED_STATIC | Static node of “Sponsored |
| | Recommendations”; |
| | associated with a query for all |
| | sponsors recommending |
| | photo content represented by |
| | the content stored in the |
| | content source |
| PHOTO_SPONSORS_DYNAMIC | Represents search results that |
| | includes sponsors of the |
| | current user that are |
| | recommending photo content |
| VIDEO_RECOMMENDED_SPONSORED_STATIC | Static node of “Sponsored |
| | Recommendations”; |
| | associated with a query for all |
| | sponsors recommending |
| | video content represented by |
| | the content stored in the |
| | content source |
| VIDEO_SPONSORS_DYNAMIC | Represents search results that |
| | includes sponsors of the |
| | current user that are |
| | recommending video content |

It should be understood that the node types listed in Table 1 are presented by way of example, and not limitation and that other embodiments can include different node types that correspond to any category of content. In particular, other embodiments include for example, node types corresponding to any one of e-book content, video content, audio content, still imagery, applications, animations, games, television programs, movies, video recordings, music, audio recordings, podcasts, radio programs, spoken audio, audibooks, photos, graphics, directors, actors, authors, publishers, speakers, genres, new content, high definition content, favorite content, content for a particular user, run times, MPAA ratings, review ratings, television episodes, awards, cast and crew, synopsis, biographies, credits, meta tags, and the like.

The tree nodes are composed of two groups, “static nodes” and “dynamic nodes”. A static node in the tree structure is a virtual node in the media server application. It does not refer to any existing entity on the content source. A static node is usually the top level node in a content tree and is used as a parent container of a specific content type. For example, MUSIC_ARTIST_STATIC is displayed as “Artists” and its children are the music artist content containers. A dynamic node in the tree structure represents the result set of a search operation. A dynamic node represents at least one of content objects and container objects of the content source.

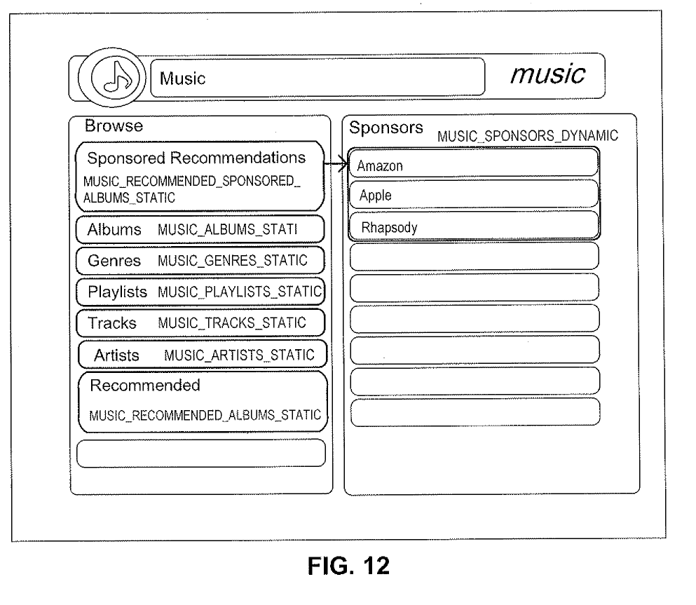

Queries corresponding to static nodes are static queries, meaning that they are not based on a previously executed query. Queries corresponding to dynamic nodes are dynamic queries, meaning that they are based on a selected search result of a previously executed query. For example, when the user navigates to the static node “Artists”, a static query for all “Artists” is executed. The visual representations of matching artists (such as “Bon Jovi”, “Nina Simone” and “Patti Austin”) are displayed as the results of the static query, and these results correspond to a dynamic node. The dynamic node is associated with a dynamic query that is based on selected search results that correspond to the dynamic node. FIG. 12 shows an example of static nodes and dynamic nodes in the user interface presented by the presentation layer module.

In the example shown in FIG. 12, the user selects the visual representation of the MUSIC_RECOMMENDED_SPONSORED_STATIC node, a static query for all sponsors is executed, the sponsors recommending music content represented by the content stored in the content source, In response to execution of the static query, visual representations of sponsors who are recommending music content are displayed as the results of the static query. In the example embodiment, the visual representations of the sponsors are names of the sponsors, however, in other embodiments, the visual representations can be any other type of visual representation. These results correspond to the dynamic node MUSIC_SPONSORS_DYNAMIC, The dynamic node MUSIC_SPONSORS_DYNAMIC is associated with a dynamic query that is based on selected search results that correspond to the dynamic node MUSIC_SPONSORS_DYNAMIC.

A tree node also supports sorting. Different sort criteria can be specified for each node. For example, objects represented by a tree node can be sorted by the name of the objects, the date of the objects, and the original order of the objects. The hierarchical tree structure is generated by adding nodes. Thus, sort criteria for at least one query in the hierarchical tree structure can be specified, such that for each query having a specified sort criteria, search results obtained by executing the query are sorted in accordance with the respective sort criteria. An existing hierarchical tree structure is configurable by adding, removing, or replacing nodes.

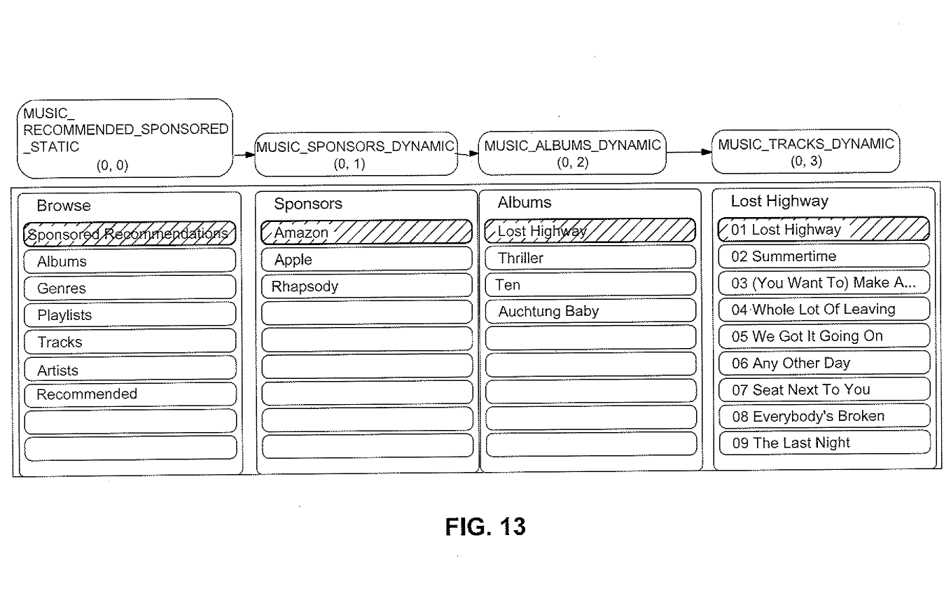

FIG. 13 is a diagram for explaining a browse feature or operation that uses the getChildren( ) module of the guided browse function. A content container object knows where it is located in the tree structure because the position is kept during generation. When a user selects a visual representation of a container object and the getChildren( ) module of the guided browse function is called, the container object composes proper search parameters according to the tree structure. It uses its child node to know what kind of child objects it should search for. It uses its current position and its parent nodes to know what node types have been selected. Using FIG. 13 as an example, the following case shows how guided navigation interacts with users.

The static node “Sponsored Recommendations” represents a container object. If the user selects the visual representation for the static node “Sponsored Recommendations” via the user interface presented by the presentation layer module 401, the guided browse function 404 executes the following static query to search for all sponsors who are recommending music content: “upnp:class derievedfrom “object..sponsors.sponsorsRecommendingMusic””. As indicated in this example, the guided browse function 404 searches for a class derived from an object for sponsors who are recommending music content. One of ordinary skill recognizes other searches such as for or by genre or album. As mentioned above, the search may use the UPnP and/or DLNA protocol, or another type of protocol. The guided browse function 404 returns visual representations for sponsors who are recommending music content, “Amazon”, “Apple”, “Rhapsody”, as results to the presentation layer module 401. The results “Amazon”, “Apple”, “Rhapsody”, correspond to the dynamic node MUSIC_SPONSORS_DYNAMIC. In the example embodiment, each of these results corresponds to a sponsor object. The dynamic node MUSIC_SPONSORS_DYNAMIC is associated with a dynamic query that is based on selected search results that correspond to the dynamic node MUSIC_SPONSORS_DYNAMIC. In the example depicted in FIG. 13, the user selects the visual representation for “Amazon”, and the guided browse function executes the following dynamic query to search for all albums recommended by the selected sponsor “Amazon”: “upnp:class derievedfrom “object..container.album.musicAlbum” and upnp:recommendingSponsor_sponsorID=“Amazon””. This dynamic query is based on the selected search result “Amazon” of the previously executed static query for all sponsors who are recommending music content.

The guided browse function 404 returns visual representations for albums “Lost Highway”, “Thriller”, “Ten” and “Auchtung Baby” as results to the presentation layer module 401. The results “Lost Highway”, “Thriller”, “Ten” and “Auchtung Baby” correspond to the dynamic node MUSIC_ALBUMS_DYNAMIC. In the example embodiment, each of these results corresponds to a container object. The dynamic node MUSIC_ALBUMS_DYNAMIC is associated with a dynamic query that is based on selected search results that correspond to the dynamic node MUSIC_ALBUMS_DYNAMIC. In the example depicted in FIG. 13, the user selects the visual representation for “Lost Highway”, and the guided browse function executes the following dynamic query to search for all tracks for the album “Lost Highway” that was recommended by “Amazon”: “upnp:class derivedfrom “object.item.audioItem.musicTrack” and upnp:album=“Lost Highway” upnp:recommendingSponsor_sponsorID=“Amazon””. This dynamic query is based on the selected search result “Lost Highway” of the previously executed dynamic query all albums recommended by the selected sponsor “Amazon”. In the example depicted in FIG. 13, after executing the dynamic query, the guided browse function returns visual representations for content objects for each of 9 tracks. The visual representations for content objects for each of 9 tracks correspond to the dynamic node MUSIC_TRACKS_DYNAMIC. If the user selects the visual representation for the content object “01 Lost Highway”, the presentation layer module plays the track “01 Lost Highway”.

FIG. 14 is a diagram for explaining recommendations, in accordance with an example embodiment. Recommendations are browsed by querying the content source 102, by using the search functionality of the content source 102. The content source 102 accesses a content database 1401 that stores content information 1402 far content provided by the content source. In the example embodiment, the content database 1401 also stores the content 1403 provided by the content source. However, in other example embodiments, the content is stored separately from the content information. In the example embodiment, the content database 1401 is internal to the content source 102, but in other embodiments, the content database is external to the content source. In the example embodiment, the content information 1402 is generated by the content source, but in other embodiments, the content information is generated by another source and accessed by the content source. In the example embodiment, the content source 102 includes a recommendation engine 1404 that generates and adds recommendations to the content database as content information 1402, such that the guided browse function can search the recommendations provided by the content source 102 by using search functionality of the content source 102. In other embodiments, an external recommendation engine generates and adds the recommendations to the content database as content information, such that the guided browse function can search the recommendations provided by the content source by using search functionality of the content source. In the example embodiment, the recommendation engine 1404 includes a sponsor database 1407. In other example embodiments, the sponsor database is external with respect to the recommendation engine 1404.

In the example embodiment, the content database 1401 stores user profiles 1405 and device profiles 1406. In other example embodiments, the user profiles and device profiles can be stored externally from the content database 1401, such as for example, in a profile database.

User profiles 1405 includes user profiles for users that access content stored in content source 102. When the media server 400 application of FIG. 4 is used by a user to accesses the content source 102 for the first time, the media server application performs user registration to register the user with the content source 102. User registration is used to identify and/or authorize a particular individual person, or group of people, for access to content, stored in the content source 102, via the media server 400. During the user registration, a user profile is generated for the user and stored in user profiles 1405. The user profile includes user identification information for the user being registered, as well as user preferences information. In an example embodiment, user preference information includes preferred content identification information that identifies content that the user prefers. Examples of other user preference information includes authors, writers, actors, directors, producers, or the like, that are preferred by the user, information identifying content that the user prefers, information related to categories, genres, or the like, that are preferred by the user, information identifying other users and/or viewers who may share an similar interests with the user, minimum content ratings that the user prefers, awards that the user prefers, languages that the user prefers, year of release that the user prefers, and any other type of user preference information.

In the example embodiment, the media server 400 performs user platform registration or “device registration” to register the media server 104 with the content source 102 when the media server 400 application accesses the content source 102 for the first time. User platform registration is used to identify and/or authorize a particular device or interface for access to content stored in the content source 102. During the device registration, a device profile is generated for the device and stored in device profiles 1406. The device profile includes device identification information for the device being registered, as well as device information. In an example embodiment, device information includes information identifying software and services supported by the device, information identifying hardware resources of the device and the like. Example hardware resources include memory resources, processing resources, network resources, and the like.

When the guided browse function 404 uses the search functionality of the content source to execute a search query on behalf of a user, the content source 102 updates the user's profile based on the search query. The terms of the search query includes user identification information for the current user and information identifying a displayed item currently selected by the user. The content source 102 accesses the user profile that matches the user identification of the current user, and adds the terms of the search query to the user profile of the current user. In particular, the terms of the search query are added to a browsing history of the user profile. When the media player accesses the content source 102 to play, run and/or display content selected by the user, the media player accesses the stored user identification information of the current user and uses the content object interface 502 to provide the user identification information of the current user to the content object for the selected content. The content object adds information identifying the content that is selected to be played, run or displayed to a consumed content history of the user profile for the current user that is identified by the user identification information provided by the media player.

In an example embodiment, the presentation layer module 401 includes a user input for receiving a user-entered rating for a selected item. In response to receiving a user-entered rating via the user input, the presentation layer module 401 provides the user-entered rating to the corresponding content source, and the user-entered rating is added to the user's profile for the content source. The user-entered rating can be a user-entered rating for a content object, a container object, or any displayed content information for which the presentation layer module 401 provides a user input for receiving a user rating

Thus, a user profiles 1405 of the content source 102 includes user identification information for the user being registered, user preferences information, a user browsing history, a user consumed content history, and user-entered ratings.

In the case where the content source is an aggregated content provider that aggregates content from other content sources, in an example embodiment, the aggregated content provider includes a content database that stores content information for content provided by the other content sources. In an example embodiment, the content database of the aggregated content provider includes content information provided by the other content sources, user profiles provided by the other content sources, device profiles provided by the other content sources, content information generated by the aggregated content provider, user profiles generated by the aggregated content provider, and/or device profiles generated by the aggregated content provider. In an example embodiment, the aggregated content provider includes a recommendation engine that generates and adds the recommendations as content information stored in the content database. In another embodiment, the recommendation engine is external to the aggregated content provider. In other example embodiments, the recommendations are provided by the other content sources, and included in the content database of the aggregated content provider.

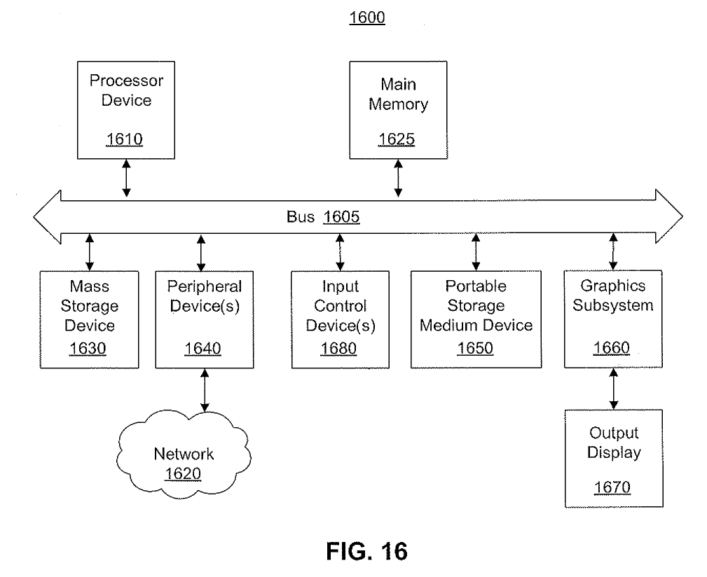

In the example embodiment, the content source 102 is stored as computer-executable process steps encoded in machine-executable instructions. The computer-executable process steps are for providing content stored in the content source, as well as for providing content information related to the content stored in the content source. The computer-executable process steps of the content source 102 are stored in a storage device of a computer, such as, for example, the computer described below with respect to FIG. 16. The computer-executable process steps of the content source 102 are executed by at least one processor of the computer

In other embodiments, the content source 102 is a hardware device that includes electronic circuitry constructed to provide content stored in the content source, and to provide content information related to the content stored in the content source. In an example embodiment, the electronic circuitry includes special purpose processing circuitry that is constructed to provide content stored in the content source, and to provide content information related to the content stored in the content source. In other example embodiments, the electronic circuitry includes at least one general purpose processor that is constructed to execute computer-executable process steps encoded in machine-executable instructions that are stored on the computer-readable storage medium of the hardware device. The computer-executable process steps executed by the general purpose processor include computer-executable process steps for providing content stored in the content source, and for providing content information related to the content stored in the content source.

FIG. 15 is a flow diagram for explaining sponsored recommendations, in accordance with an example embodiment.

At block 1501, the recommendation engine 1404 of FIG. 14 accesses the sponsor database 1407 of FIG. 14. The sponsor database 1407 stores sponsor information for one or more sponsors identified by the sponsor database 1407. In the example embodiment, the sponsor information includes a sponsor identification (ID), a sponsor state, sponsor display information, and one or more sponsored recommendations.

In the example embodiment, the sponsor state identifies a sponsor as active or inactive. In the example embodiment, a sponsor is active if the sponsor has been authorized by the content source 102 to provide sponsored recommendations, and the sponsor is not active if the sponsor has not been authorized by the content source 102 to provide sponsored recommendations. For example, in a case where sponsors provide payment to be authorized to provide sponsored recommendations, a sponsor is active if its payment has been received.

At block 1502, the recommendation engine 1404 obtains sponsor identifications information from the sponsor database 1407 for each active sponsor.

At block 1503, the recommendation engine 1404 accesses sponsored recommendations provided by each active sponsor. In example embodiment, a sponsored recommendation is received from an active sponsor. In another embodiment, the recommendation engine 1404 accesses a recommendation service provided by the sponsor, and accesses sponsored recommendations via the sponsor's recommendation service.

At block 1504, the recommendation engine 1404 converts the accessed sponsored recommendations into a format of the content database. At block 1505, the recommendation engine 1404 and adds the converted sponsored recommendations to the content database.

In an example embodiment, the content database 1401 receives the sponsored recommendations directly from the sponsor. In an example embodiment, the format of the sponsored recommendations received from the recommendation service are not converted.

In the example embodiment, each sponsored recommendation includes content identification information for content recommended by the sponsor, and a sponsor identification for the sponsor.

At block 1505, the recommendation engine 1404 adds the generated sponsored recommendations to the content database 1401, as content information 1402. The sponsored recommendations are added to the content database 1401 in association with respective content 1403, as identified by the content information included in the sponsored recommendation, and in association with the sponsor identification for the sponsor upon whom the sponsored recommendation is based. In an example embodiment, the recommendation engine adds the sponsor's identification to the content database 1401 as content information 1402 for content 1403 that has a content identifier that matches the content identifier of the sponsored recommendation.

### Example Computer Readable Medium Implementation

The example embodiments described above such as, for example, the systems 100, 200, and network 101, or any part(s) or function(s) thereof, may be implemented in one or more computers or other processing systems. Useful machines for performing the operation of the example embodiments presented herein include general purpose digital computers or similar devices.

FIG. 16 is a block diagram of a general and/or special purpose computer 1600, in accordance with some embodiments. The computer 1600 may be, for example, a user device, a user computer, a client computer and/or a server computer, among other things.

The computer 1600 includes without limitation a processor device 1610, a main memory 1625, and an interconnect bus 1605. The processor device 1610 may include without limitation a single microprocessor, or may include a plurality of microprocessors for configuring the computer 1600 as a multi-processor system. The main memory 1625 stores, among other things, instructions and/or data for execution by the processor device 1610. The main memory 1625 may include banks of dynamic random access memory (DRAM), as well as cache memory.

The computer 1600 may further include a mass storage device 1630, peripheral device(s) 1640, portable storage medium device(s) 1650, input control device(s) 1680, a graphics subsystem 1660, and/or an output display 1670. For explanatory purposes, all components in the computer 1600 are shown in FIG. 16 as being coupled via the bus 1605. However, the computer 1600 is not so limited. Devices of the computer 1600 may be coupled through one or more data transport means. For example, the processor device 1610 and/or the main memory 1625 may be coupled via a local microprocessor bus. The mass storage device 1630, peripheral device(s) 1640, portable storage medium device(s) 1650, and/or graphics subsystem 1660 may be coupled via one or more input/output (I/O) buses. The mass storage device 1630 is a nonvolatile storage device for storing data and/or instructions for use by the processor device 1610. The mass storage device 1630 may be implemented, for example, with a magnetic disk drive or an optical disk drive. The mass storage device 1630 is configured for loading contents of the mass storage device 1630 into the main memory 1625.

The portable storage medium device 1650 operates in conjunction with a nonvolatile portable storage medium, such as, for example, a compact disc read only memory (CD-ROM), to input and output data and code to and from the computer 1600. In some embodiments, the media server application may be stored on a portable storage medium, and may be inputted into the computer 1600 via the portable storage medium device 1650. The peripheral device(s) 1640 may include any type of computer support device, such as, for example, an input/output (I/O) interface configured to add additional functionality to the computer 1600. For example, the peripheral device(s) 1640 may include a network interface card for interfacing the computer 1600 with a network 1620.

The input control device(s) 1680 provide a portion of the user interface for a user of the computer 1600. The input control device(s) 1680 may include a keypad and/or a cursor control device. The keypad may be configured for inputting alphanumeric and/or other key information. The cursor control device may include, for example, a mouse, a trackball, a touchpad, a stylus, and/or cursor direction keys. In order to display textual and graphical information, the computer 1600 includes the graphics subsystem 1660 and the output display 1670. The output display 1670 may include a cathode ray tube (CRT) display and/or a liquid crystal display (LCD). The graphics subsystem 1660 receives textual and graphical information, and processes the information for output to the output display 1670.

Each component of the computer 1600 may represent a broad category of a computer component of a general and/or special purpose computer. Components of the computer 1600 are not limited to the specific implementations provided here.

Portions of the disclosure may be conveniently implemented by using a conventional general purpose computer, a specialized digital computer and/or a microprocessor programmed according to the teachings of the present disclosure, as will be apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a computer-readable storage medium or media having instructions stored thereon or therein which can be used to control, or cause, a computer to perform any of the procedures of the disclosure. The computer-readable storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable storage medium or media, some implementations include software for controlling both the hardware of the general and/or special computer or microprocessor, and for enabling the computer or microprocessor to interact with a human user or other mechanism utilizing the results of the disclosure. Such software may include without limitation device drivers, operating systems, and user applications. Ultimately, such computer readable storage media further includes software for performing aspects of the disclosure, as described above.

Included in the programming and/or software of the general and/or special purpose computer or microprocessor are software modules for implementing the processes described above.

While various example embodiments of the present disclosure have been described above, it should be understood that they have been presented by way of example, and not limitation. It will be apparent to persons skilled in the relevant art(s) that various changes in form and detail can be made therein. Thus, the present disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for browsing content stored in a content source, comprising the steps of:
accessing a hierarchical tree structure having nodes that correspond to at least one query for recommended content that is recommended based on sponsored recommendations;
browsing the recommended content stored in the content source by executing the at least one query for recommended content, the at least one query corresponding to at least one node of the hierarchical tree structure, the browsing being performed in accordance with a hierarchy of the hierarchical tree structure.

2. The method according to claim 1, wherein the content source includes a recommendation engine that adds sponsored recommendations to the content source as content information, and the sponsored recommendations of the content source are searched by using a search functionality of the content source.

3. The method according to claim 2, wherein the recommendation engine stores sponsor information for one or more sponsors, the sponsor information including a sponsor identification (ID), a sponsor state, sponsor display information, and one or more sponsored recommendations, the sponsor state identifying a sponsor as active or inactive.

4. The method according to claim 3, a sponsor is active if the sponsor has been authorized by the content source to provide sponsored recommendations, and the sponsor is not active if the sponsor has not been authorized by the content source to provide sponsored recommendations.

5. The method according to claim 3, wherein content identification information for content recommended by the sponsor, and a sponsor identification for the sponsor, and the recommendation engine adds the sponsor's identification to the content source as content information for content that has a content identifier that matches the content identifier of the sponsored recommendation.

6. The method according to claim 6, wherein the recommendation engine:
obtains sponsor identification information for each active sponsor;
accesses recommendations provided by each active sponsor;
converts the accessed sponsored recommendations into a format of the content database;
adds the converted sponsored recommendations to the content source, as content information.

7. A guided browse function for browsing content stored in a content source, the guided browse function comprising:
a computer-readable storage medium storing a hierarchical tree structure having nodes that correspond to at least one query for recommended content that is recommended based on sponsored recommendations;
electronic circuitry constructed to browse the recommended content stored in the content source by executing the at least one query for recommended content, the at least one query corresponding to at least one node of the hierarchical tree structure, the browsing being performed in accordance with a hierarchy of the hierarchical tree structure.

8. The guided browse function according to claim 7, wherein the content source includes a recommendation engine that adds sponsored recommendations to the content source as content information, and the sponsored recommendations of the content source are searched by using a search functionality of the content source.

9. The guided browse function according to claim 8, wherein the recommendation engine stores sponsor information for one or more sponsors, the sponsor information including a sponsor identification (ID), a sponsor state, sponsor display information, and one or more sponsored recommendations, the sponsor state identifying a sponsor as active or inactive.

10. The guided browse function according to claim 9, a sponsor is active if the sponsor has been authorized by the content source to provide sponsored recommendations, and the sponsor is not active if the sponsor has not been authorized by the content source to provide sponsored recommendations.

11. The guided browse function according to claim 10, wherein content identification information for content recommended by the sponsor, and a sponsor identification for the sponsor, and the recommendation engine adds the sponsor's identification to the content source as content information for content that has a content identifier that matches the content identifier of the sponsored recommendation.

12. The guided browse function according to claim 11, wherein the recommendation engine:
obtains sponsor identification information for each active sponsor;
accesses sponsored recommendations provided by each active sponsor;
converts the accessed sponsored recommendations into a format of the content database;
adds the converted sponsored recommendations to the content source, as content information.

13. A computer-readable storage medium on which is stored computer-executable process steps for causing a computer to browse content stored in a content source, said process steps comprising:
accessing a hierarchical tree structure having nodes that correspond to at least one query for recommended content that is recommended based on sponsored recommendations;
browsing the recommended content stored in the content source by executing the at least one query for recommended content, the at least one query corresponding to at least one node of the hierarchical tree structure, the browsing being performed in accordance with a hierarchy of the hierarchical tree structure.

14. The computer-readable storage medium according to claim 13, wherein the content source includes a recommendation engine that adds sponsored recommendations to the content source as content information, and the sponsored recommendations of the content source are searched by using a search functionality of the content source.

15. The computer-readable storage medium according to claim 14, wherein the recommendation engine stores sponsor information for one or more sponsors, the sponsor information including a sponsor identification (ID), a sponsor state, sponsor display information, and one or more sponsored recommendations, the sponsor state identifying a sponsor as active or inactive.

16. The computer-readable storage medium according to claim 15, a sponsor is active if the sponsor has been authorized by the content source to provide sponsored recommendations, and the sponsor is not active if the sponsor has not been authorized by the content source to provide sponsored recommendations.

17. The computer-readable storage medium according to claim 16, wherein content identification information for content recommended by the sponsor, and a sponsor identification for the sponsor, and the recommendation engine adds the sponsor's identification to the content source as content information for content that has a content identifier that matches the content identifier of the sponsored recommendation.

18. The computer-readable storage medium according to claim 17, wherein the recommendation engine:
obtains sponsor identification information for each active sponsor;
accesses sponsored recommendations provided by each active sponsor;
converts the accessed sponsored recommendations into a format of the content database;
adds the converted sponsored recommendations to the content source, as content information.
